(19) United States
(12) Patent Application Publication
(10) Pub. No.: US 2017/0355295 A1
(43) Pub. Date: Dec. 14, 2017

(54) Collective Transportation Systems

(71) Applicant: Howard Gutowitz, New York, NY (US)

(72) Inventor: Howard Gutowitz, New York, NY (US)

(73) Assignee: Howard Gutowitz, New York, NY (US)

(21) Appl. No.: 15/618,013

(22) Filed: Jun. 8, 2017

Related U.S. Application Data
(60) Provisional application No. 62/347,482, filed on Jun. 8, 2016.

(51) Int. Cl. B60P 3/07; G05D 1/02; B62D 63/02; B60P 3/32

(52) U.S. Cl. CPC B60P 3/07; B60P 3/32; G05D 1/0293; B62D 63/025; G05D 2201/0212; B60Y 2200/112; G05D 2201/0213

(57) ABSTRACT

A method and apparatus are presented for a collective transportation system. The system comprises a plurality of container automated vehicles and a plurality of containable automated vehicles each of which may be contained in a container vehicle, so that one or more containable vehicles are nested within a containable vehicle and may be transported by the container. The containable vehicles may move around within the interior of a container, preferably under control of a controller which controls the motion of all the containable vehicles within a container vehicle, so that the controller can rearrange the contained vehicles within the container. Preferably, two container vehicles can dock with each other to exchange containable vehicles between them, under control of a controller. Preferably, dockings and transfers may occur while the container vehicles are moving. An end-to-end journey by a containable vehicle may entail many transfers between container vehicles along the way

### RELATED APPLICATIONS

This application relates to, and claims the benefit of the filing date of the provisional U.S. patent application entitled “An Internet for Transportation”, application No. 62/347,482 with filing date of Jun. 8, 2016 the entire contents of which are incorporated herein by reference and relied upon for all purposes.

### BACKGROUND OF THE INVENTION

The drawbacks of traditional, non-collective, transportation include:

1) vehicles are typically not loaded to their most efficient capacity

2) vehicles are required to have a long range, resulting in their being over-dimensioned in many respects, in particular, they are required to transport large amounts of fuel, enough for the longest anticipated journey.

3) Switching payload (such as a passenger) from one vehicle to another is time consuming and thus costly.

4) Vehicles are designed to the lowest common denominator of the infrastructure they will traverse, meaning they are optimized for no particular segment of that infrastructure.

5) Vehicles, especially private vehicles, spend most of their time idle, even when there exists a need for transportation capacity.

Automation of individual vehicles alone is not sufficient to remove these drawbacks. Consider the problem of sub-optimal loading of individual vehicles. Ride sharing is a commonly attempted solution is: carpool. But the improvement in vehicle loading due to forming a carpool comes at a cost, the cost in time and money to collect passenger to load the vehicle and then to distribute the passengers to their individual destinations. This cost can easily overwhelm the savings from gathering people together for a ride. Without more, automation cannot solve this logistics problem.

To overcome these drawbacks what is proposed here is a system optimally integrating features of automated cars, buses and even larger vehicles into a wholly new system, a packet-switched system, which nests automated vehicles inside of other automated vehicles. Automated buses, alone, have the same drawbacks as regular buses: they have to constantly stop to pick up and drop off passengers, in the face of fluctuating demand, they are hard to keep fully loaded so they operate efficiently, they are too big for narrow or highly curved roadways, or any low-demand applications. However, when combined with automated pods, all these drawbacks can be eliminated.

In the analogy to the information internet, a packet-switched network for information, the pods are the packets, and the container vehicles are the routers. While routers in the information internet are typically stationary, and exchange packets electronically, the transportation routers exchange packets physically, and preferably while moving. The transportation routers provide a sorting and distribution function like information routers do, but also provide physical motion toward the packet's destination. This is the step at which the information internet analogy can no longer guide our understanding. It is a new property with many surprising consequences. Still, the analogy leads us to expect that the transportation internet will share with the information internet the same improvements over their circuit-switched analogues in robustness, throughput, and ease of deployment. Conceptually, the container vehicles are discrete packages of a layer of transportation and automation support between the static infrastructure and the pods. That is, rather than build static support for pods into the roadway itself, support is encapsulated in a peer-to-peer system of mobile units, where the characteristics of each unit are optimized against the physical constraints of the local section of roadway in which it moves, abstracting away those static features of the infrastructure, insulating the pods from them.

In an illustrative example journey from point A to point B, a person mounts a pod at point A, the pod drives away to mount into the interior of a feeder vehicle, preferably while both pod and feeder are in motion. The feeder perhaps accumulates more pods in this way and takes them to the highway, where it docks at highway speed with another automated vehicle and transfers its pods. The highway vehicle docks with other highway vehicles in a chain, each time transferring the pod, bringing the pod closer and closer to its destination, point B. As the destination approaches, the highway vehicle docks with another feeder, the feeder exits the highway, perhaps to dock with other feeders and further transfer the pod, until finally the pod is dismounted from a feeder, at speed, so that the pod can travel the small remaining distance to point B under its own power. This entire illustrative scenario is understood to be fully automated.

Like routers in the information internet, routers in this transportation internet may have little knowledge about the behavior of other routers, be they nearby or far away. Network operations arise from peer-to-peer interaction. Preferably, however, there is a more global router/controller managing the collective transportation system herein described, also referred to as the transportation internet (or “tnet” for short) within some geographic region, or a region otherwise circumscribed, such as within a building. The global router coordinates routing within and between vehicles operating within its control region. The global router can help the tnet achieve remarkable efficiency by fully utilizing the intrinsic capacity of the infrastructure. Theoretically, the tnet could have orders of magnitude better throughput than current transportation systems, with no increase in infrastructure, and no traffic jams despite induced demand, and even in emergency evacuation scenarios where maximum throughput away from the disaster area is required.

This disclosure first introduces some basic technical aspects of tnet structure and operation. It then covers notable extensions and details, including ways of balancing supply with demand, how various existing businesses can incorporate the tnet into their operations, and entirely new businesses can be developed to take advantage of the novel potential of the tnet.

### BRIEF DESCRIPTION OF THE DRAWINGS

The various aspects and features of the invention will be described in reference to a set of drawings, brief descriptions of which follow.

FIG. 1 An illustrative containable automated vehicle.

FIGS. 2A-B An illustration of intra-vehicle rearrangement of containable automated vehicles contained within a container automated vehicle. FIG. 2A: Configuration before rearrangement. FIG. 2B: Configuration after rearrangement.

FIGS. 3A-C An illustration of inter-vehicle transfer of containable vehicles from a first container automated vehicle to a second container automated vehicle. FIG. 3A: Configuration before transfer. FIG. 3B: Configuration during transfer. FIG. 3C: Configuration after transfer.

FIGS. 4A-C An illustration of inter-vehicle transfer of containable vehicles from a first container automated vehicle to a second container automated vehicle when first and second automated vehicles are docked. FIG. 4A: Configuration before transfer. FIG. 4B: Configuration during transfer. FIG. 4C: Configuration after transfer.

FIG. 5 A subway system comprising express and local trains comprising container automated vehicles.

FIGS. 6A-C Execution of a “go it alone” interaction between express and local trains of container automated vehicles containing containable automated vehicles. FIG. 6A: Configuration as the trains approach an express/local stop. FIG. 6B: Configuration just before the trains reach the express/local stop. FIG. 6C: Configuration just as a car of the express train goes on alone.

FIGS. 7A-B Docking of express and local trains, with transfer of pods. FIG. 7A Configuration before transfer. FIG. 7B Configuration after transfer.

FIGS. 8A-D Intra- and inter-container vehicle routing of containable vehicles in a platoon of container vehicles taking forks in a road. Top shows the position of the platoon relative to the road, bottom shows a magnified portion with just the platoon. FIG. 8A Configuration well before any fork. FIG. 8B Configuration just before first fork. FIG. 8C Configuration after first fork, before second fork. FIG. 8D Configuration after second fork.

FIG. 9 Variously dimensioned container automated vehicles.

FIGS. 10A-B A rather wide and tall container automated vehicle. FIG. 10A Top view, showing roadway for scale. FIG. 10B Side view, showing multiple decks.

FIGS. 11A-B A “yacht,” which is a traveling docked assembly of container vehicles. FIG. 11A Details of an illustrative assembled yacht. FIG. 11B Process of assembling the yacht.

FIGS. 12A-B Transport of a pod from a first neighborhood to a second neighborhood. FIG. 12A From the first neighborhood to the highway. FIG. 12B From the highway to the second neighborhood.

FIG. 13 A containable automated vehicle boarding a container automated vehicle.

FIGS. 14A-C Indoor-outdoor pods. FIG. 14A First configuration of the indoor-outdoor pods in a building. FIG. 14B Second configuration of the indoor-outdoor pods in a building. FIG. 14C Third configuration of the indoor-outdoor pods in a building.

FIGS. 15A-B An apparatus for delivering fuel to moving vehicles. FIG. 15A A tanker automated vehicle for distributing power to pods. FIG. 15B A pod for delivering power to other vehicles.

FIG. 16 Synchronizing the activities of vehicles participating in collective transportation.

FIG. 17 Combining the flow of pods and the transport of multi-modal shipping containers.

FIG. 18 Mini-containers with cargo transport detachable from a mobility unit.

FIG. 19 Loading and unloading shipping containers while they are in transit.

FIGS. 20A-B Shipping logistics in collective transportation. FIG. 20A Non-responsive logistics. FIG. 20B Responsive logistics.

FIGS. 21A-B Platoon companion vehicles. FIG. 21A Companion vehicle used as a scout for a platoon. FIG. 21B Companion vehicle used to glue two platoons together.

FIG. 22 Companion vehicle used a platoon leader.

FIG. 23 An illustrative use of drones in a collective transportation system.

FIG. 24 A mechanism for acquiring precise information during docking.

FIG. 25 A controller based on simple nearest-neighbor interaction rules.

FIG. 26 A nearest-neighbor controller navigating a fork in a road.

FIG. 27 A cover of a geographic region by control regions.

FIG. 28 Illustrative examples of optimization criteria for control regions.

FIG. 29 Illustration of network effects stimulating the growth of a collective transportation system.

### DETAILED DESCRIPTION

A collective transportation system is a transportation system comprising a plurality of container automated vehicles, a plurality of containable automated vehicles each of which may be contained in members of said plurality of container automated vehicles, and when a given said containable automated vehicle is contained within the enclosed interior of a given said container automated vehicle, said given containable automated vehicle may move about within said enclosed interior of said given container automated vehicle.

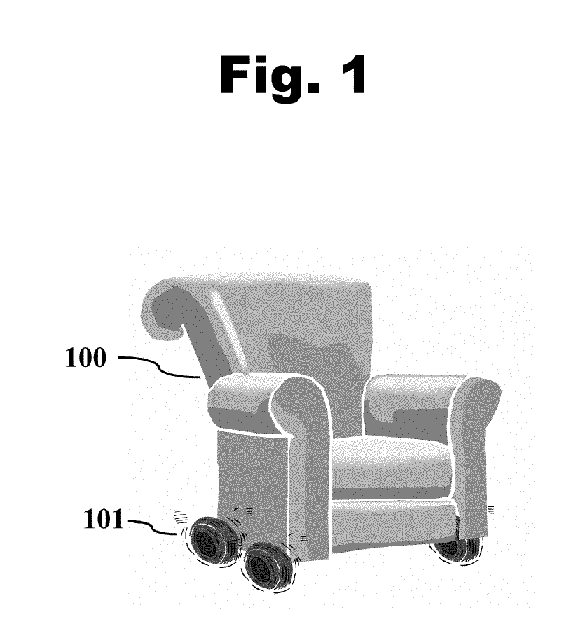

We discuss the characteristics of container vehicles below, but first introduce containable vehicles which are automated vehicles in their own right, and also such that they can be contained in container vehicles. These containable vehicles, which we will also call “pods” can move about under their own power for at least brief periods of time, and move about either outside or inside a container vehicle. Pods might transport people and/or things. A pod mainly for transporting people in a seated position might look very much like a chair, for example as shown in FIG. 1. FIG. 1 is meant to schematically represent an illustrative comfortable pod [100] for a seated person. It is equipped with a set of wheels [101] as shown, as well as a motor, sensors, and communication systems (not shown) and other mechanical and electrical systems allowing the pod to act and to have its actions be coordinated with those of other automated vehicles it may encounter, such as container vehicles or other pods. Though it is possible that a containable vehicle could contain other vehicles, and thus be a container vehicle as well, unless otherwise noted in the discussion of some illustrative embodiment, “pod” or “containable vehicle” means automated vehicles which do not contain other automated vehicles, and thus form the base unit of automated vehicle nesting in that embodiment. Pods may have many other forms, depending on their technology and intended payload among other factors, the pod of FIG. 1 is but one sample out of an infinite set of possibilities.

In the collective transportation system we are discussing, the container automated vehicles might contain more than one containable vehicle (pod), and comprise a controller which controls motion-relevant activities of said containable vehicles contained within a containing container automated vehicle, said controller able to cause said contained containable automated vehicles to move about within said enclosed interior of said container container automated vehicle, whereby said controller can rearrange relative to each other each said contained containable automated vehicle within said enclosed interior of said containing container automated vehicle.

In other words, container automated vehicles create an enclosed interior environment in which the smaller automated vehicles, the pods, can move about, under instruction from a controller. A container vehicle might be just big enough to contain a single containable vehicle with little room to drive about the interior, but will typically be able to contain more than one containable vehicle with sufficient space that they can move about with respect to each other and be re-arranged within the interior by a controller. Combining containable and container vehicles, we have a nested set of automated vehicles. Viewed from inside the container, the interior of the container is a small bit of roadway for the contained automated vehicles. Viewed from outside the container, the small bit of roadway itself moves on a roadway, the immobile infrastructure environment. (Where in this disclosure unless otherwise specified we are taking “road” or “roadway” quite generally to mean any sort of infrastructure/vehicle combination. For instance, we could be talking about automated aircraft which fly about with other automated aircraft flying about within them, snowmobiles containing other snowmobiles and traveling on snow, and so forth.) The motion of the pods inside a container vehicle is under the control of a controller, which we may also call a “router,” said controller having control over the relevant vehicles, including at least the container vehicle and the containable vehicles it contains at a given moment. Two levels of nesting are already enough to unleash some benefits of collective transportation systems, due to the property that the container vehicles can contain more than one containable vehicle, and the controller is able to cause the contained containable vehicles to move within the container vehicle whereby, when more than one containable vehicle is contained in a given container vehicle, the controller can rearrange the contained containable vehicle relative to each other within the given container vehicle though control of the rearrangement-relevant motions of each of said contained containable vehicles.

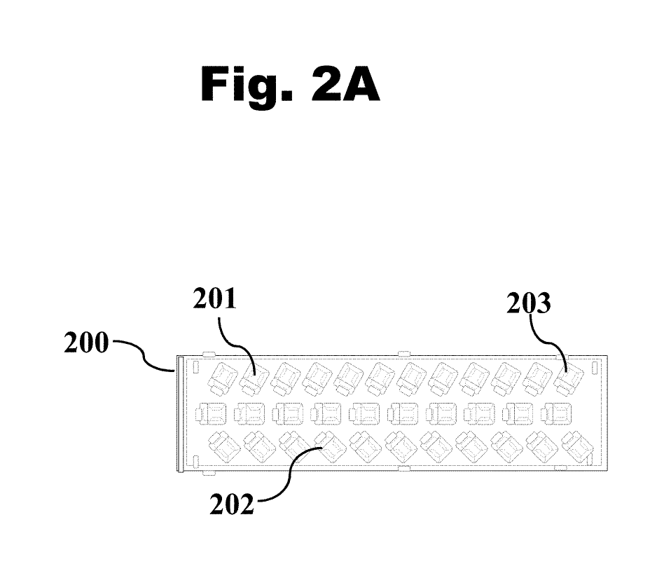

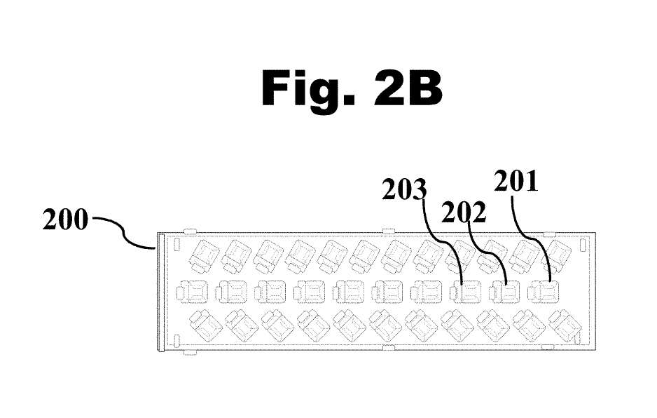

This is illustratively shown in FIGS. 2A-B to which we now turn. FIG. 2A shows a container automated vehicle [200] in top view which contains a plurality of containable automated vehicles, including the pods labelled [201]-[203]. Under direction of a controller which controls the activity of all of the pods shown in the figure relevant to the rearrangement which will occur, the pods are rearranged so that the labelled pods [201]-[203] occupy the positions shown in FIG. 2B. The pods are fairly closely packed in FIGS. 2A-B, but they can still be rearranged by the controller much as tiles slide about in a tile puzzle. To achieve this, however, the controller needs to control all rearrangement-relevant motions of each of the pods, meaning any motions which might advance or interfere with the desired rearrangement. We may refer to the process by which containable vehicles are rearranged within a given container vehicle as intra-vehicle routing.

It should be noted that some aspects of some embodiments to be presented below might be executed not by fully automated pods, but by people receiving instructions from a controller by some means, such as cell phones. Where common sense dictates that some aspect of some embodiment could be safely and reliably executed by a non-fully-automated vehicle, that aspect should be understood as not requiring full automation.

The intra-vehicle routing just discussed can be contrasted with inter-vehicle routing in which one or more pods transfer from one container vehicle to another one. To effect this, the controller needs to control the transfer-relevant motions of both sending and receiving container vehicles, as well as the motions of the pods to be transferred, and any other pods which need to move to allow the transfer to take place. This includes pods within both the sending and receiving vehicles since the receiving vehicle should clear room to receive any pods it will receive in the transfer. If there are pods circulating outside of the container vehicles along the desired path of the pods transferring between them, then the sphere of control of the controller should extend to any of those circulating pods which might interfere with the transfer.

More formally, the collective transportation system just described could also be such that when a first member of a plurality of container automated vehicles contains a to-be-transferred member of a plurality of containable automated vehicles and a second member of said plurality of container automated vehicles has room to receive and contain yet another member of said plurality of containable vehicles in addition to any of said containable vehicles already contained in said second container automated vehicle, then said controller may coordinate the motion and other transfer-relevant actions of said first and second container automated vehicles as well as actions of said to-be-transferred containable automated vehicle so as to effect the transfer of said to-be-transferred containable automated vehicle from within said enclosed interior of said first container automated vehicle to said enclosed interior of said second container automated vehicle whereupon said to-be-transferred containable automated vehicle is contained in said second container automated vehicle and is thereby deemed to be transferred.

By transfer-relevant actions we mean any actions that any vehicles involved in the transfer might need to take. For instance, given that pods have a certain range over which they can travel on their own power, the sending and receiving vehicles need to travel so that they are within that range from each other. As the pod will be leaving one enclosed interior space and entering another, doors have to open and close, and so controlling exit and entry portal machinery is another transfer-relevant action which falls under the domain of the transfer controller. The receiving vehicle has to have room to receive the new pod, and might have to move the pods it already contains, if any, in order to clear that room. Again, a task for the transfer controller. The receiving container vehicle might also have to prepare to supply services to the new pod, such as power, HVAC, and a data hookup, a matter for the transfer controller to co-ordinate as well. Though we will often refer to such controllers as “routers” it should be borne in mind that many other activities of the relevant automated vehicles might have to be managed by the controller, beyond simply controlling the motion of the automated vehicles, and control of those other activities is assumed when not explicitly mentioned. Other operations of the automated vehicles may not be relevant to the collective-transportation activity under discussion, and thus might not need to be co-ordinated by the router. For instance, unless otherwise mentioned, the entertainment system of a pod, if any, need not be managed by the controller aka router, and might be left to the control of the pods passenger, if any.

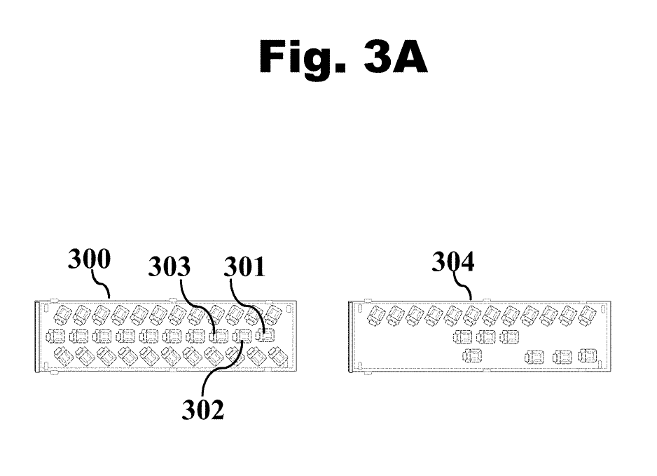

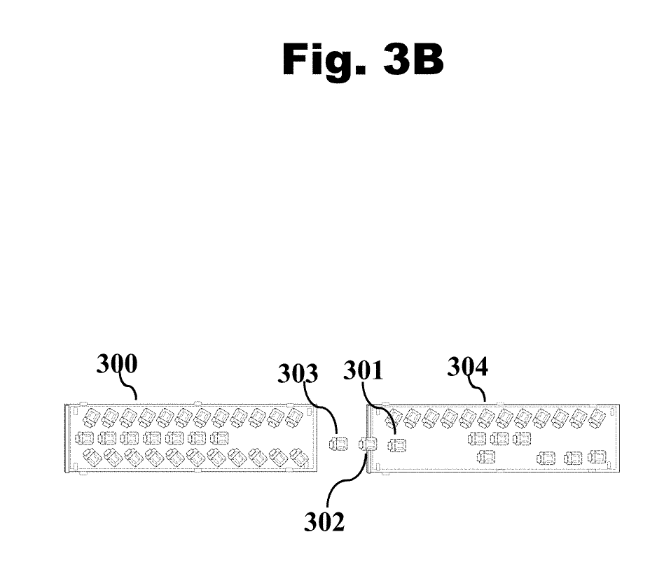

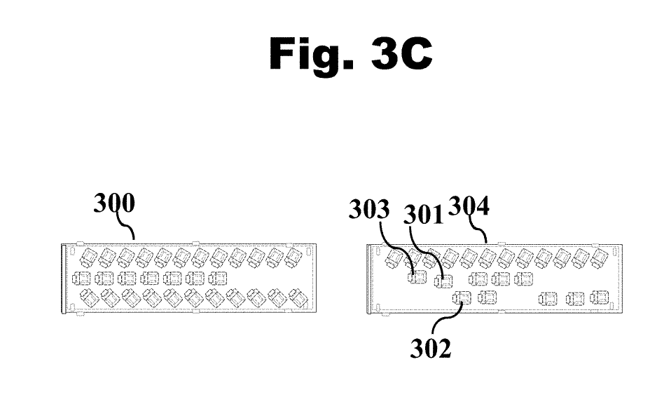

Returning to FIG. 2, we saw how selected pods, initially scattered throughout a container vehicle, could be brought into line via intra-vehicle routing. If there were an exit door in front of that line, the selected pods would be well positioned to exit the container vehicle through that door and transfer to another container vehicle. This process is illustrated in FIGS. 3A-C to which we now turn. FIG. 3A, FIG. 3B, and FIG. 3C show the configuration of the container and containable vehicles before, during, and after the transfer respectively In this process, the controller is controlling not only the motion of the vehicles, but also door opening and closing and any other transfer-relevant machinery which operates during transfer.

In detail, Each panel of FIG. 3 shows a first container automated vehicle [300] containing a plurality containable automated vehicles, and a second container automated vehicle [304] containing a second plurality of containable automated vehicles. Over the course of the sequence from FIG. 3A to FIG. 3C, three of the containable automated vehicles [301]-[303] transition from being members of said first plurality of containable vehicles to being members of said second plurality of containable vehicles by transferring from said first container vehicle to said second container vehicle. The transfer is done under control of a controller which supervises the activities of all of the automated vehicles [300]-[304] and any other vehicles, such as other members of said first and second pluralities of containable vehicles which might be incidentally involved in the transfer. The controller manages not only the motions of the vehicles, but also the transfer-relevant behavior of their component parts. For example, the controller is responsible for co-ordinating the opening and closing of doors of the first and second container vehicles. If the containable vehicles need to be configured for transfer, e.g. need to be sufficiently fueled for the transfer to be effected, the controller will see to that configuration as well.

We now consider the case where the transfer-relevant actions of the first and second container automated vehicles discussed just above includes temporary and reversible joining of the enclosed interiors of the first and second container automated vehicles forming a joint enclosed interior space such that the to-be-transferred containable vehicle may transfer from the first container automated vehicle to said second container automated vehicle while wholly within said joint enclosed interior space. The temporary, reversible process by which two container automated vehicles join to merge their interiors will also be referred to here as “docking”. When docked, container vehicles act together as if they were one vehicle, under the control of the same controller (or multiple controllers intimately co-ordinated in all respects which concern actions of one vehicle which affect the other vehicle, such that “multiple” vs “same” controller is a distinction without a difference). Docking may, and as we shall see preferably typically does, occur while both vehicles are moving, perhaps at high speed. The speed at which automated vehicles can will be able to dock will depend on the level of technology in many domains of mechanical, electrical and computer engineering, which level can be anticipated to always improve. Therefore, technology will reach the point at which docking may safely, quickly, and efficiently occur at any speed at which container automated vehicles can travel. In what follows, docking at slow speeds or even when container vehicles are stopped is fully within the scope of our considerations, though the better vehicles can dock seamlessly, without breaking speed and without otherwise making excessive accommodation, the better and more efficiently the systems we describe will work. Since many docking may occur during a journey of a pod, any small reduction in the time such dockings take will have a large impact on the effectiveness of the system as a whole.

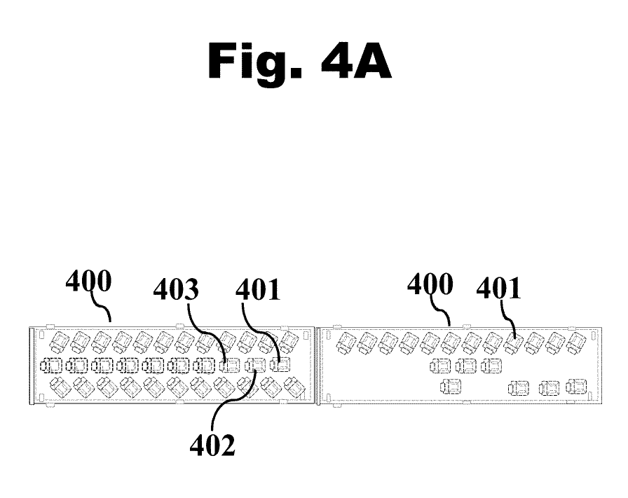

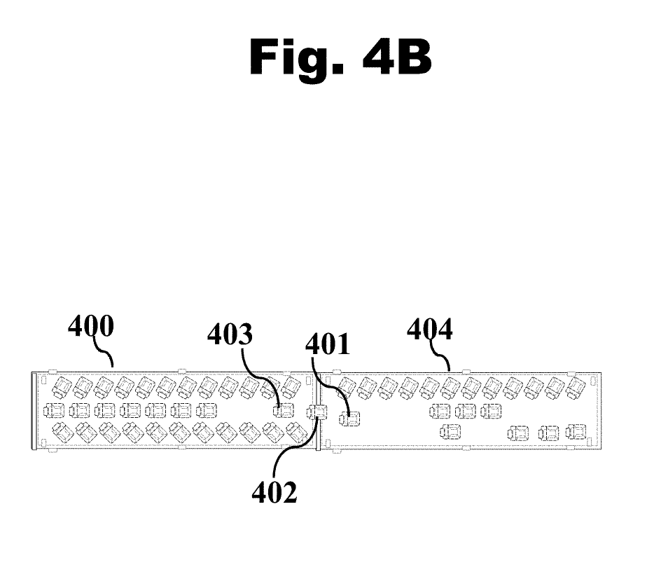

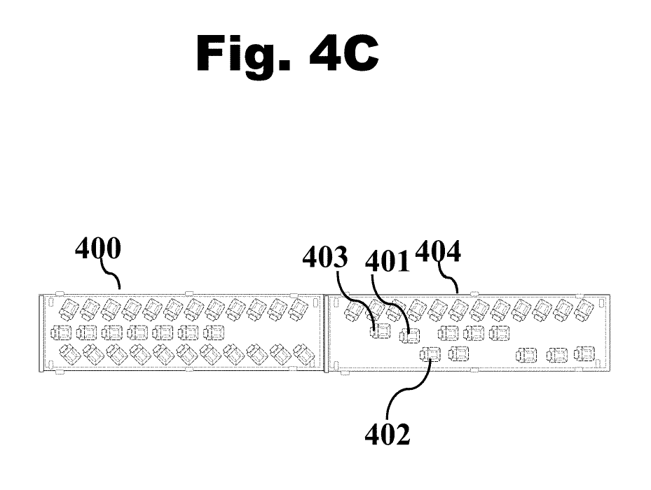

We now turn to FIGS. 4A-C which shows the state of two container vehicles and their contained pods respectively before, during, and after the movement of three pods from the left container vehicle to the right one, while left and right containers are docked (and potentially moving at high speed). From the point of view of the pods, the joint interiors of the docked container vehicles are just a large continuous space to move about in. It is immaterial to them that the whole assembly might be moving, even at high speed. Here, a few of the pods move from one vehicle to the other. If the purpose of that docking was to transfer those pods, the containers can undock once that happens. Throughout the transfer process, the other pods may be moving about also, to facilitate the present transfer, or to prepare for some future transfers. In short, FIGS. 4A-C are similar to the just discussed FIGS. 3A-C, with the additional feature of docking. That is, the container automated vehicles [400] (left) and [404] (right) are capable of docking with each other while the corresponding container vehicles [300] and [304] of FIGS. 3A-C are not necessarily capable of docking. The three to-be-transferred pods [401]-[403] are initially contained wholly in the left container vehicle (FIG. 4A) and move through the joint enclosed interior space of left and right containers which was created by the docking of [400] and [404] (FIG. 4B), until they are wholly contained within the left container vehicle (FIG. 4C).

Thus we see that a collective transportation system could be such that temporary and reversible joining of the enclosed interiors of a first and second container automated vehicles may occur while both the first and second container vehicles are in substantial motion with respect the infrastructure on which they travel. Typically, though both vehicles are moving at substantial speed relative to the infrastructure while they dock, their motion relative to each other approaches zero as the docking completes. Ideally, the motion with respect to the infrastructure during docking is substantial enough that impact of docking on the throughput of the system is negligible. The mind of the person of average skill in the art rebels against the notion of vehicles docking and undocking potentially at high speed that we have just presented, even leaving aside the aspect of transferring people between vehicles docking and undocking at high speed. This is part of what prevents such a person from inventing the inventions of the present disclosure or making the appended claims. On aspect of what is preventing the person of average skill in the art from making the inventive leaps required is the failure to realize that the “mind meld” between two automated vehicles which is required for safe docking at substantial speed is impossible for human intelligence, but feasible for artificial intelligence.

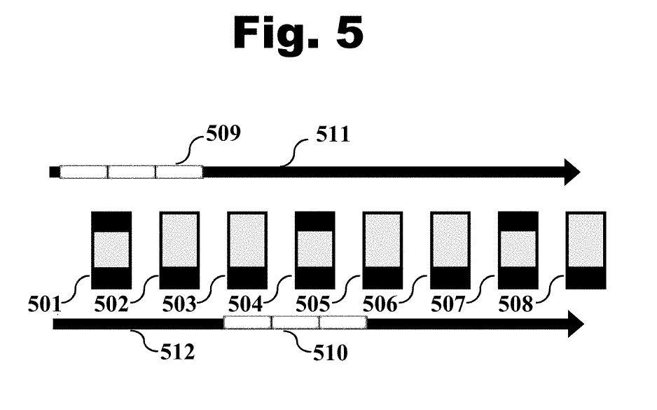

To help illuminate the scope of the appended claims, we now present an illustrative embodiment in which various aspects and features of those claims is applied to a subway system. In particular, we will see how intra- and inter-vehicle routing can improve the efficiency of a subway system. Turning to FIG. 5, we see a subway system with express and local trains running on parallel tracks. In this system the express can stop at every third local stop. There is a controller which controls both trains, and all the pods they contain. It knows all relevant information about the state of the system, including the destination of each the pods. It can route pods within and between cars of the same train at any time, and between trains whenever both are at an express/local stop.

In detail, FIG. 5 schematically shows an express train [509] running on an express track [511] and a local train [510] running on a local track [512]. There are local platforms [501]-[508] at which the local train [510] may stop. Certain local stops are also express stops. Namely, [501], [504] and [507] are express/local platforms where either of the trains

or [510] may stop. The controller of both the express and the local trains knows the destination of all of the passenger containable automated vehicles and can route passengers accordingly, within the train and between trains.

This simple transportation system is already rich enough to illustrate many of the challenges and opportunities which pertain to all sufficiently complex collective transportation systems, and in particular the range of potential responsibilities of the controller/router in such systems. In general, such a system will be set up achieve some balance of doing what is best for 1) the system as a whole and 2) the individual traveller. These goals could be in conflict. For instance, the system might want to maximize system-wide throughput while minimizing the average travel time between any pair of points A and B. It might be willing to sacrifice goals of individual travelers to achieve these system-wide goals. For instance, if there were only one pod waiting at a platform, a train might not stop if doing so would delay many other passengers, negatively impacting global throughput. Skipping the stop would be bad for the individual, but beneficial for the system as a whole.

On the other hand, an individual traveler might have a weighted set of goals, such as minimize 1) time to destination, 2) number of transfers, 3) crowding. Optimizing these individual goals might negatively impact system-wide goals.

There are many possible subgoals which might preferentially benefit the system as a whole, or an individual passenger, or both. For example, the system may strive to minimize dwell time on the platform, or minimize the maximum dwell time.

Here are some representative tactics the system might use to optimize its performance. These give some flavor of the new powers of collective transportation systems.

1) Go it alone. If a train can fill front cars with passengers going beyond the next stop, the front cars are filled with such passengers via intra-vehicle transfers within the same train. Then, those filled cars can then decouple from the train and continue onward to the first stop where any of its passengers need to disembark, without stopping at intermediate stops. Stopping would be disfavored since the car(s) are already full, and no passenger is set to disembark at the station.

2) Beat the express. The local can retain passengers if it will arrive at the next express stop before an actual express car with available space arrives at the next express station.

3) Overshoot. The system may route a downtown passenger beyond their destination stop if no one else in the car shares that destination stop. At the cost of the overshot passenger having to take an uptown train to backtrack, the other passengers get to their destination sooner.

4) Play for the other team. The express may stop at a nominally local-only stop if doing so would increase general throughput. This might be the case, for instance, if it could fill an entire car with passengers going to a distant express stop, if only it made that atypical local stop. Then it could apply tactic 1).

In view of this last tactic, it may be that a system operates with no distinction being made at all between local and express trains. Each track could work with the other to move passengers quickly to their destinations, with each car on each track stopping at or skipping stations as required to achieve maximum throughput, highest average speed, or some other performance goal. Similarly, subway cars may link up with each other or not, depending on the need to route passengers between cars vs continuing independently at the maximum speed available, and consistent with not being able to move beyond other cars ahead on the track.

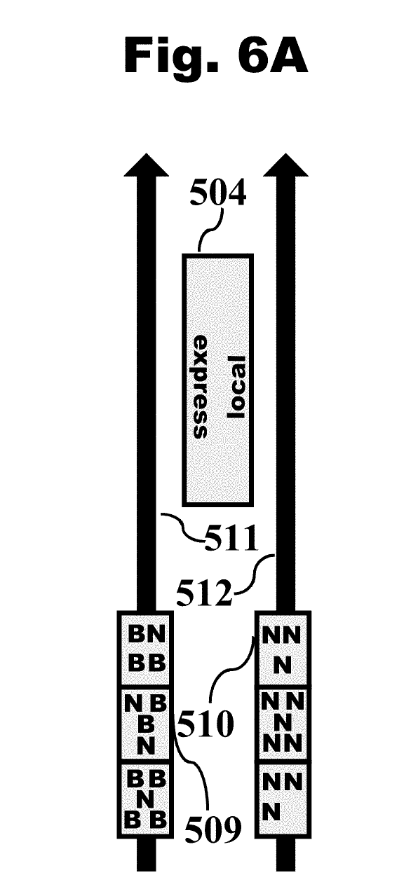

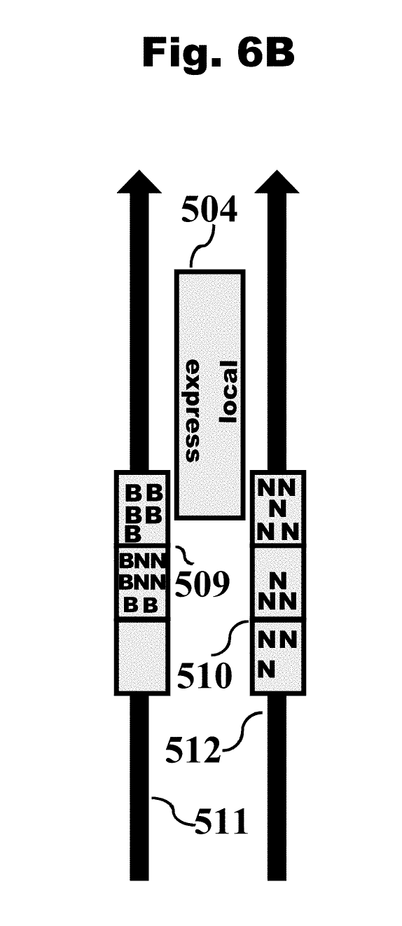

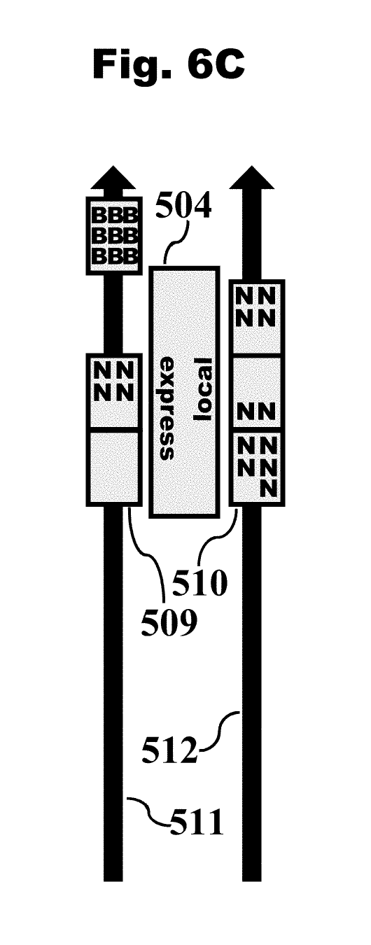

For further illustration, we will now work out in more detail how the “go it alone” tactic could be executed. FIGS. 6A-C each show a detail around one of the local/express stops of FIG. 5, stop [504]. At this level of detail we see that there are two classes of pods in the trains: B (“beyond”) pods, whose destination is at or beyond the next local/express stop [507], and N (“next”) pods which are exiting at one of the next local stops beyond [504] but before [507], namely stops [505]-[506]. The configuration of B and N pods as the express [509] and local [510] trains approach the local/express stop [504] is shown in FIG. 6A. Before the stop is reached, the express train routes B pods to the first car, and N pods to the other cars, construction of this configuration is shown in progress in FIG. 6B. Meanwhile, the local train rearranges its pods so there is an empty space in its middle car, sufficiently large to receive the set of N pods in the express train, also seen in progress in FIG. 6B. When the express train [509] reaches station stop [504], the N pods go straight across the platform to the space cleared for them in the local train [510], the situation just before this happens is shown in FIG. 6C. Meanwhile, as also seen in FIG. 6C, the first car of the express train [509] undocks from the rest of the train and speeds ahead. The first express car does not stop at all, since there is no need. By going it alone, it increases throughput of the system as a whole, and provides a direct benefit to the B pods it contains.

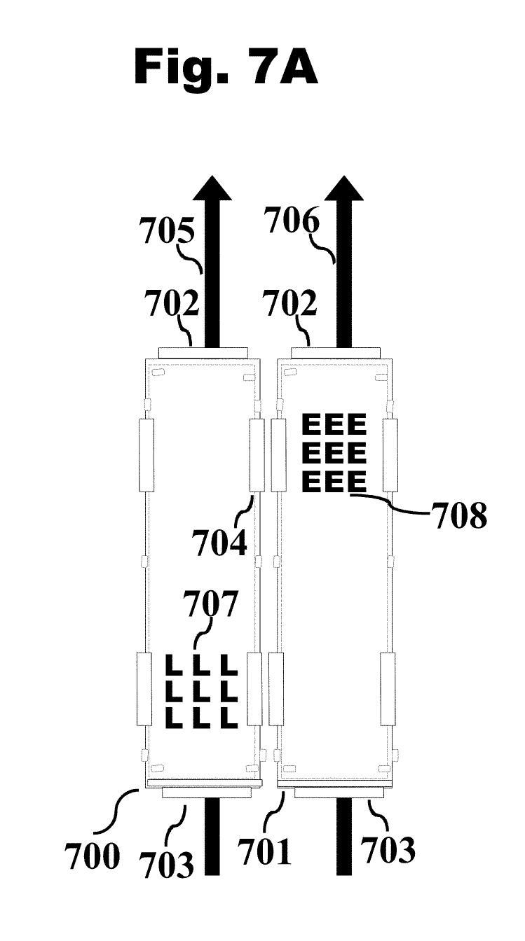

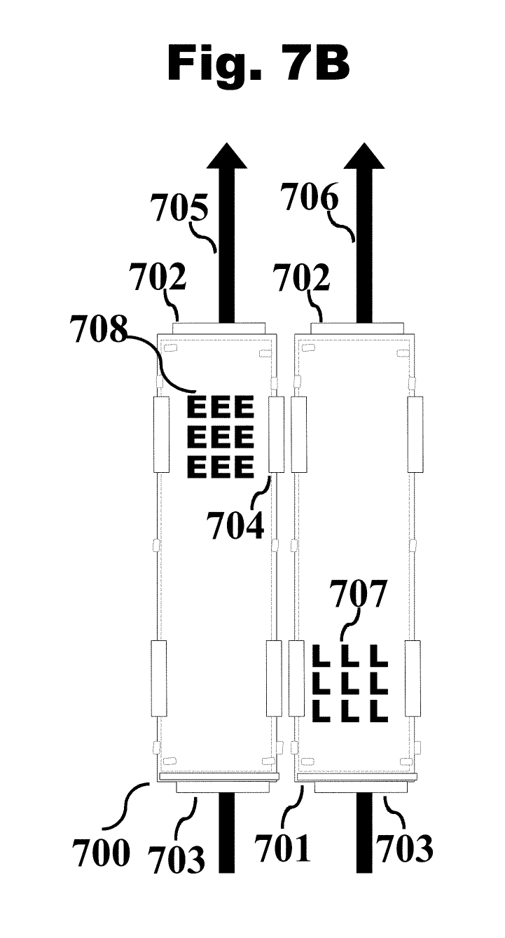

When container vehicles can dock while moving, transfers can happen on the fly, between stops. We have already seen that when pods and container vehicles work together, dwell time at transfer stops can be vastly reduced. This is accomplished by sorting pods together in the transfer-from container, and clearing a corresponding space in the transfer-to vehicle. The transfer can be so fast, in fact, that there is no real need for the container vehicles to stop at all for a transfer. As long as the container vehicles can securely link together for the moment it takes to do the transfer, they can perform the transfer while in motion. Let's look again at our local and express trains by turning to FIGS. 7A-B. Here we see a transfer being performed between trains between subway stations, while the trains are in motion. The express [700] and local [701] trains are running on closely parallel tracks [705] and [706] respectively. For transfers, they precisely match their speeds and positions, then link lateral doors [704] to form secure passages between the trains by joining their enclosed interiors. The train cars are also equipped with forward [702] and rear [703] doors for use to link to other cars on the same track. In preparation for a transfer, each train rearranges its contained pods, gathering together L pods [707], which wish to be on the local train, and separately gathering E pods [708], which wish to be on the express train. At the same time, corresponding space is cleared in the destination train in anticipation of receiving more pods. Given this preparation, the transfer can happen quickly. After the transfer, all pods are in their desired train. The trains decouple and continue independently, at their own speed. FIG. 7A shows the arrangement just before the transfer, and FIG. 7B shows the arrangement just after the transfer.

The pod distribution sub-system. Since all routing within and between trains does not require the trains to stop, subways built built on these principles could dispense with platforms entirely. Provided, that is, some way to load pods into the system, and remove them at their destination. Loading pods onto trains and unloading them at their destination could also be performed without stopping trains, as we will see below. For now we note that the pod distribution system could have numerous variants. The pods could be privately or publicly owned, or owned by a corporation, or some mix. That in turn would impact pod management. In the case of passenger-owned pods, the pod is likely to enter and exit the subway along with the passenger, and pod routing would be the same as passenger routing. In other cases, a separate pod-routing system would be needed, capable of dealing with empty and full pods, and making sure they are there when needed, and absent when not. Present bike-share systems provide a taste of how that might work, if we imagine that bikes could redistribute themselves. A system-supplied pod would need to return to the system to be redistributed once it has dropped off its passenger. This induced trip may affect the routing of the primary trip, in that there may be a tradeoff between efficiency in providing the primary trip and efficiency in redeployment of the empty pod afterwards. The global router would need to weigh these perhaps competing effects according its overall goals, such as optimizing system-wide throughput and costs, perhaps further weighted against quality of service commitments, if any, made to the passenger.

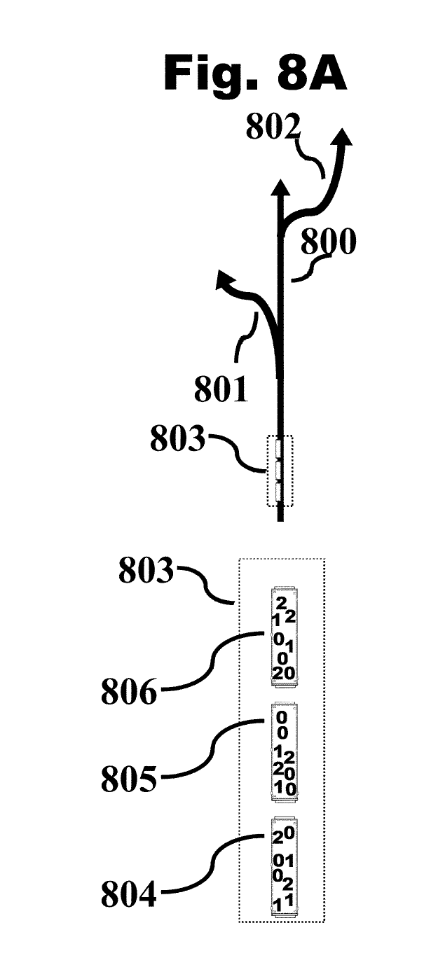

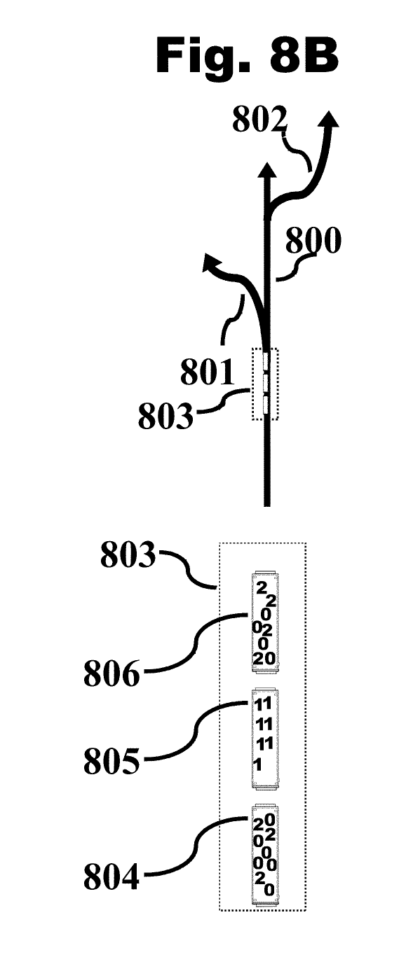

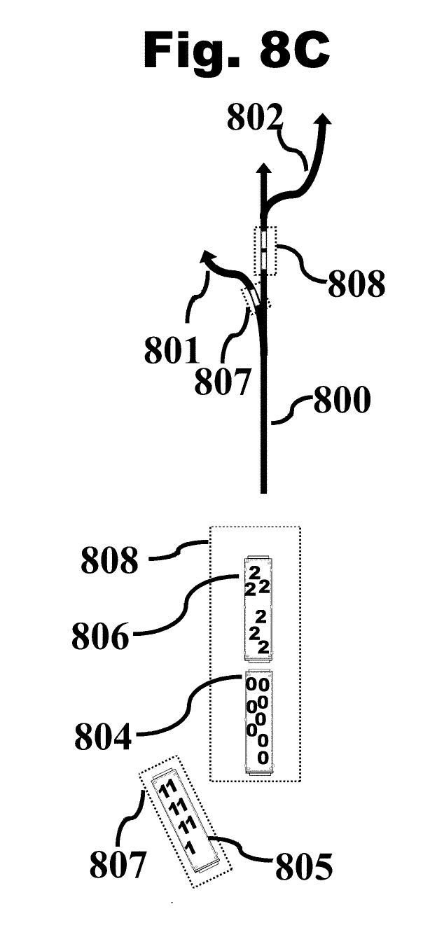

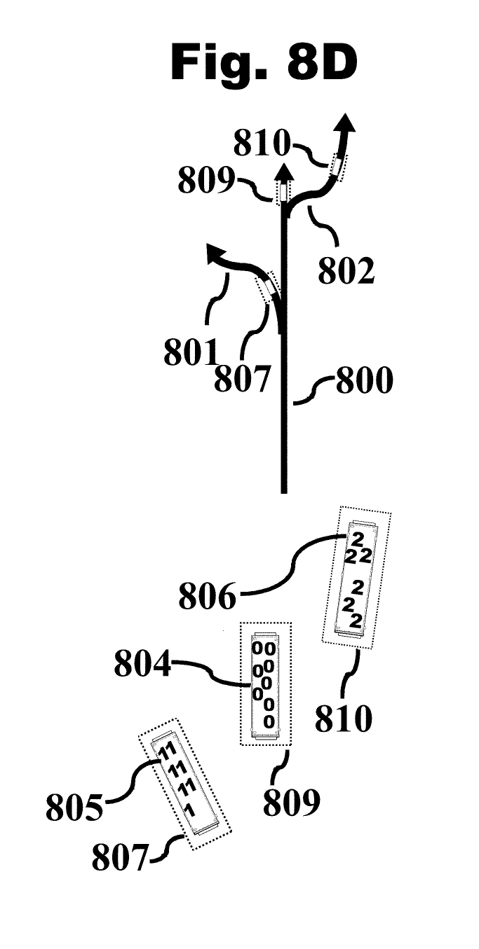

As a further illustrative embodiment, let us consider routing flow through branching highways. Having eliminated the need for platforms, we now eliminate tracks by considering trackless systems, such as might be traversed by wheeled vehicles, hovercraft, aircraft, tanks, snowmobiles, etc. We will assume in this example that there exists an infrastructure such as a roadway with defined paths along which vehicles are guided, but the same principles apply in the absence of such paths. This example shows how a collective transportation system can deal with a fork in the road by applying the features which have already been disclosed. Accordingly, we turn to FIGS. 8A-D which shows a platoon of three vehicles traveling a highway [800] approaching branches in the road, first [801] and then [802]. The successive figures FIG. 8A through FIG. 8D show successive snapshots of the progress of the platoon down the road, and the intra- and inter-routing of pods which occurs as time progresses. Highway vehicles tend to travel closely together in platoons to facilitate exchange of pods between them. In the present instance, The container vehicles in the platoon [804]-[806] dock with each other, generally front to back, when they need to exchange pods and while otherwise continuing on their journey In FIG. 8A, the platoon is shown in a dotted-line bounding box [803], which is magnified below the depiction of the roadway. The magnification allows us to see that the platoon vehicles [804]-[806] contain pods labelled 0, 1, and 2 according to whether their route takes them down highway branches [800]-[802] respectively, each container containing some pods of each type. In FIG. 8B, the 1 pods have been sorted in the middle container vehicle [805], and the 0 and 2 pods sorted out of that container [805] into the other ones, [804] and [806]. Then, in FIG. 8C, the container vehicle [805] splits off from the platoon to take its 1 pods along highway branch [801]. The bounding box showing the region of magnification now splits into two parts, [807] for the container [805] and [808] for the other two container vehicles, which are here still on the branch [800] forming a reduced platoon. In FIG. 8D, the reduced platoon has just passed the highway branch [802], before reaching it, pods of type 0 were sorted in container vehicle [804], which remains on branch [800] after the split, while pods of type 2 were sorted into container vehicle [806] which takes them along highway branch [802]. The magnification bounding box [808] has split into two pieces, [809] and [810] to follow container vehicles [804] and [806] respectively on their path beyond the fork in the road.

A given pod will experience the routing process just described being executed many times in the course of a long journey on a complex road network. On entering a branch, a container vehicle joins a platoon traveling that branch, and exchanges pods with the other members of the platoon as required to get each and every pod to its final destination. A given pod can expect to change containers at least at every branch, though it may occasionally get sorted into a container following the pods desired route over several branches. Exchanges may occur in a platoon even when no branch is imminent. Exchanges might be needed for load balancing between the vehicles, for instance.

It is to be noted that we have, for the sake of exposition, split the routing of the different classes of pods into phases. In actual implementation, the platoon could begin to route pods among the vehicles in the platoon as soon as they have relevant information, such as the destination of the pods in the platoon. Also note that for the sake of compact exposition, this illustration shows three vehicles in the platoon and three possible routes. In general there need not be any particular relationship between the number of vehicles in a platoon and the number of branches in the route ahead. Indeed, there need not be a platoon at all, merely multiple container vehicles capable of docking together to exchange pods between them.

We have already seen that in a collective transportation system each vehicle contributes to only a segment of a pod's journey. It wouldn't be efficient to use a large highway vehicle to pick up individual pods, or deliver them to their final destination. The non-highway segments will be best served by non-highway vehicles, adapted for non-highway travel, and thus typically smaller, slower, and more numerous than highway vehicles. That is, we envision a collective transportation system of where the plurality of container automated vehicles includes a sub-plurality of road vehicles designed for travel on roadways, said sub-plurality comprising optimized sub-pluralities of container automated vehicles optimized relative to one or more infrastructure standards created by a well-established standards-setting body, including standards for road width, clearance height, or design speed, where members of each said optimized sub-plurality are optimized with respect their utilization of the intrinsic capacity of said roads built to said infrastructure standard which defines said optimized sub-plurality of container automated vehicles.

In particular, for each type of roadway in a network of roads, there could be a type of vehicle which is built to use that type of roadway to best advantage in transporting pods. In biology, an indication that two kinds of animals are of different species is that they are unable to breed together. A similar indication allows us to see that two vehicles are optimized with respect to different standards. E.g a vehicle which is optimized for travel on a standard American interstate limited-access highway could very wide and high, and travel at great speed so as to use as much as possible of the intrinsic capacity for pod throughput of a lane of interstate. Such a vehicle might be too big to travel on roads built to another standard, say the standard for New York City cross-town streets. Even if its width and height were such that it could fit on a cross street, it would not be able to travel at its design speed since other factors, such as cross traffic or the presence of pedestrians might make that at least unwise. Conversely, a container vehicle designed to the standard for New York City cross streets might be able to fit on an interstate, but it would be too small and slow to fully use the intrinsic capacity of that roadway. We are already familiar with “multi-modal” transportation, where a person or unit of cargo might travel part of its journey on a road, a next part on a train, a next part on a boat, etc. In those terms, collective transportation could be massively multi-modal, where each traditional mode is broken into numerous sub-modes each providing a niche for a special type of vehicle, which does its work in transporting pods while remaining in its niche, and then transferring the pod to a different type of vehicle when the pod needs to leave that niche to complete its journey. Vehicles in one niche will be able to dock with vehicles of at least one other type, so that pods can move across modes. Thus we expect that vehicles of one type will be able to travel on roads of some other type, albeit with less efficiency, for the purposes of transferring pods to vehicles of another type. Similarly, transfers can happen across traditional modes, so that, e.g., a road vehicle could dock with a train or an airplane (while the plane is on the ground) to transfer pods. There could be still more specialized container vehicles whose purpose is to couple vehicles of different species, receiving pods from one species via docking, and later docking with vehicles of the other species to off-load the pods. All of this will require that the relevant standards bodies act to set standards for docking mechanisms to allow pod transfers across modes and sub-modes, much as standards have already been set for intermodal shipping containers.

In connection with FIGS. 8A-D, we discussed transfers of pods between container vehicles all living in the same niche. A different type of vehicle, probably smaller and slower, and adapted to life on non-highway surface streets would be used to ferry pods to the highway and from the highway. We will call such vehicles “feeder vehicles” since they feed pods into the highway which is the backbone of the transportation system in that it performs the bulk of the transportation. Indeed, and in analogy with the information internet backbone, we will call the highway-adapted vehicles “backbone vehicles” or BBVs for short. Feeders and BBVs work together as parts of a collective, as we will now examine.

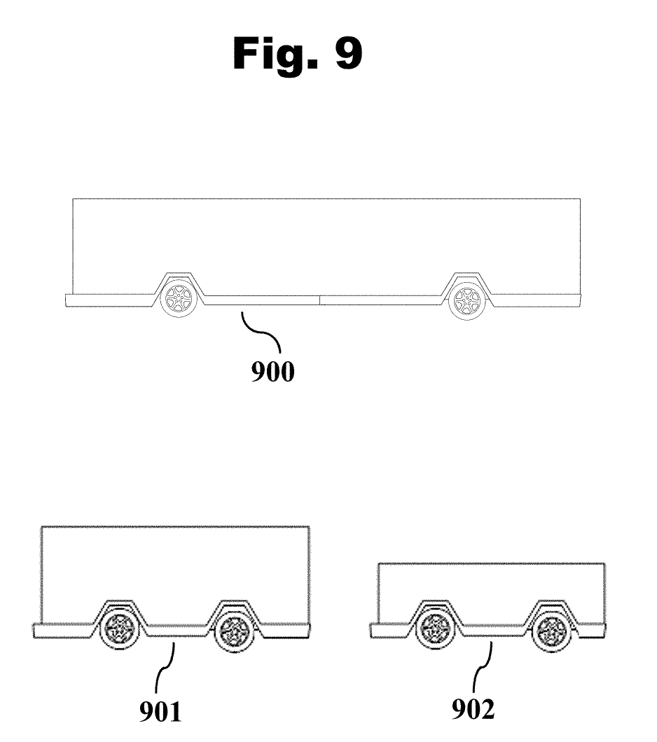

Turing now to FIG. 9, we see at the top a large highway-worthy container vehicle, a BBV, in side view [900]. BBVs spend much or all of their time on the highway, or poised to enter the highway on short notice. Indeed, they may be so big that they are incapable of travel on regular surface streets. They are specialized for life on the highway. Feeder vehicles, are typically smaller, capable of containing fewer pods, and are better adapted for traveling surface streets. They may come in different sizes, depending on a variety of factors, such as the nature of the surface streets in a local neighborhood and the volume of pods to be transported in that neighborhood. Two feeders are shown in the bottom of FIGS. 9 [901] and [902], giving an illustrative sense of their potential relative size compared to BBVs. For feeders, think of sizes in the range from panel van to school bus.

Feeders are container vehicles just like BBVs, in that they are capable of containing pods and exchanging them with other container vehicles such as BBVs or other feeders. Feeders can generally travel both on the highway and on surface streets, though they spend most of their time on surface streets. They generally enter the highway only to deliver pods to BBVs, or to pick up pods from a BBV to take them to surface streets. They may never enter the highway if they are designed to interact only with other feeders on surface streets. Feeder vehicles are typically smaller than BBVs, typically travel at slower speeds than BBVs. Those feeder vehicles which can dock with BBVs can match BBV speed and door placement and orientation as required in order to dock with them. Similarly, feeders can match speed, door placement and orientation with each other to perform inter-feeder transfers. Though feeders might travel on the highway, when they do they are not using the full intrinsic capacity of the highway, being too narrow or low or slow, or all of the above.

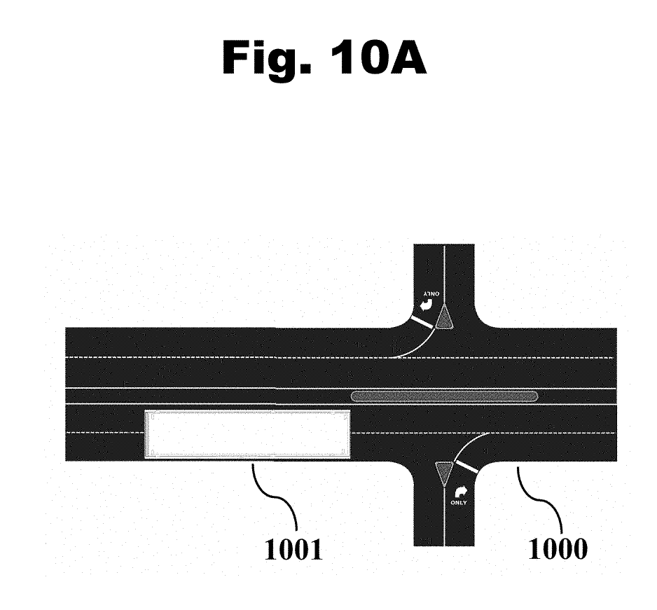

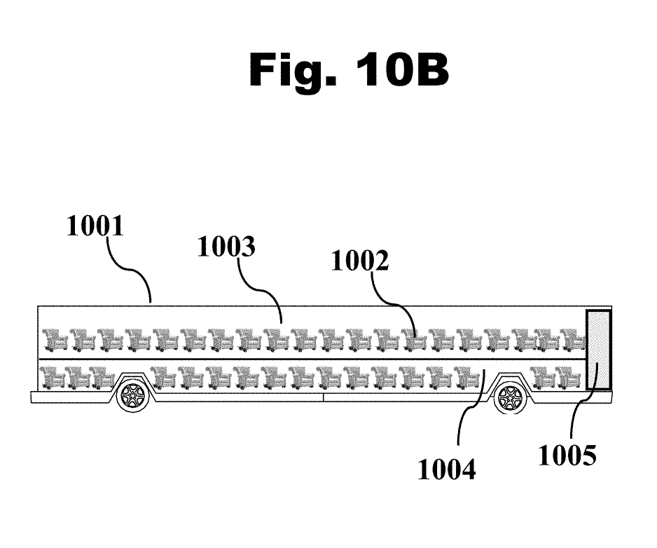

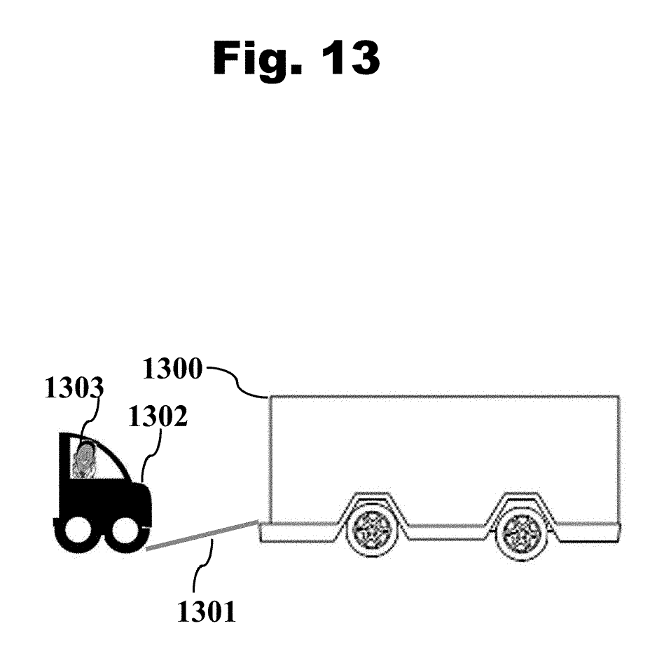

Economies of scale can apply to backbone vehicles. Bigger vehicles can be more efficient and they can offer better services. Road vehicles are presently limited in size by three main factors, 1) the dimensions of roadways, and 2) the costs in time and money of loading and unloading large vehicles to their most efficient operating level, 3) the need for vehicles to be dimensioned so as to travel effectively all roads. But collective transportation systems mitigates all these factors. In particular they excel at load balancing for peak effectiveness, so roadway dimensions remain as the only real constraints. Further, since container vehicle are passed pods to transport from other container vehicles, and pass them on to still further container vehicles, they can be specialized to take advantage of economies of scale available in limited patches of roadway Notably, on multi-lane roads vehicles in a collective transportation system the can be bigger than any common prior-art vehicle in one or more of length, width, and height. Consider, for instance, the vehicle [1001] of FIG. 10A which occupies two lanes, and is shown from above on a roadway [1000] to give a sense of scale. Note that this vehicle is so large that it could not make the a turn onto the cross streets shown. Such a design is counter-intuitive to intuition based on non-collective transportation systems such as we have in the prior art, but clearly advantageous to the collective systems under consideration here, since they better exploit the intrinsic capacity of that section of roadway than any prior-art vehicle could. The consequence of not being able to turn onto the side street would make such a vehicle unacceptable for wide-spread use in a traditional transportation system. Here, by contrast, there is no problem. Any pod the vehicle [1001] contains which needs to take the cross street would get there via another container vehicle optimized for the cross-street but capable of entering the backbone for the purpose of docking with the vehicle [1001] it finds there. Alternatively, the pod might be discharged from the vehicle onto the roadway to travel the cross street on its own. See the discussion in connection to FIG. 13 for further details. Furthermore, now looking at [1001] in sideview as shown in FIG. 10B, we see that it [1001] has two decks [1003]-[1004] for use by contained pods [1002], with a pod elevator [1005] connecting the decks. It is able to support multiple decks since its height is limited only by the clearance under overpasses on that segment of roadway on which the vehicle operates, and despite lower clearances on adjacent and connecting roads. One some other segment of road still taller vehicles could operate, with three or more pod decks. The pod elevator [1005] is preferably under control of the same controller which controls the movement of all of the pods [1002] contained in the container [1001]. This allows the controller to efficiently manage the distribution of pods across its decks. Thus we have a collective transportation system of comprising clearance-height optimized container automated vehicles with a height that allows them to contain more than one level for transport and rearrangement of standard height pods, with the levels connected by a pod elevator.

The niche for the vehicle [1001] comprises the set of interconnected roads on which the vehicle can travel, being all roads with sufficient width, clearance height and limited curvature. Since the vehicle can leave its niche only with difficulty, maintenance of the vehicle should be generally done within the niche, and installation of a vehicle in its niche might entail assemble of the vehicle within the niche, and it might have to be de-assembled to be permanently removed from the niche. These considerations provide still other reasons that a person of average skill in the art would never alight on such a non-intuitive transportation solution.

Though “collective” is a politically freighted term, the mechanisms of collective transportation disclosed herein are ideologically neutral. Within this scope, nothing prevents great indulgence in private wealth and privilege. Take, for example, what we will call BBV yachts. Yachts are large vehicles which can be assembled out of other, typically also large vehicles. Yachts might be privately owned, and might even contain no public right of way though the property. Yachts could play a transportation eco-system role similar to that of private ships or airplanes today, or private railcars in the past. of the past. The yacht could even be a part of a private transportation network owned by an individual or a corporation, comprising a fleet of private pods and feeders which service the yacht.

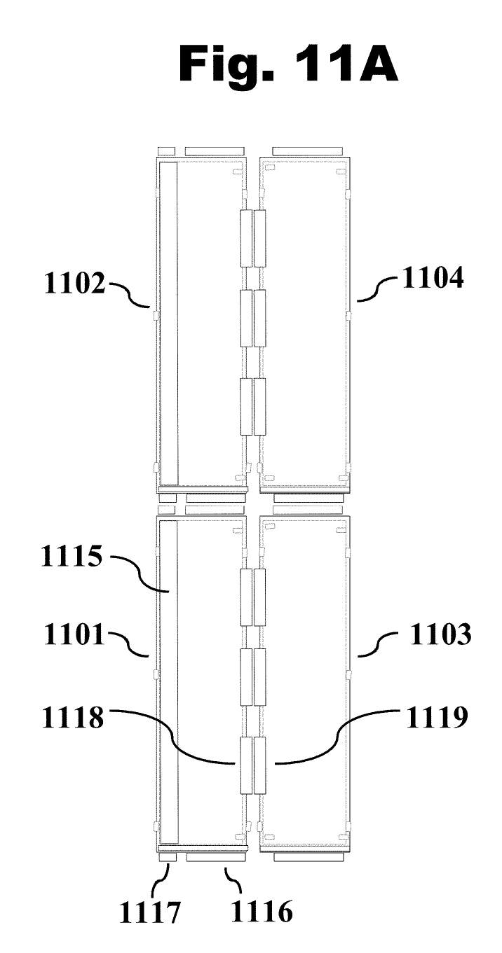

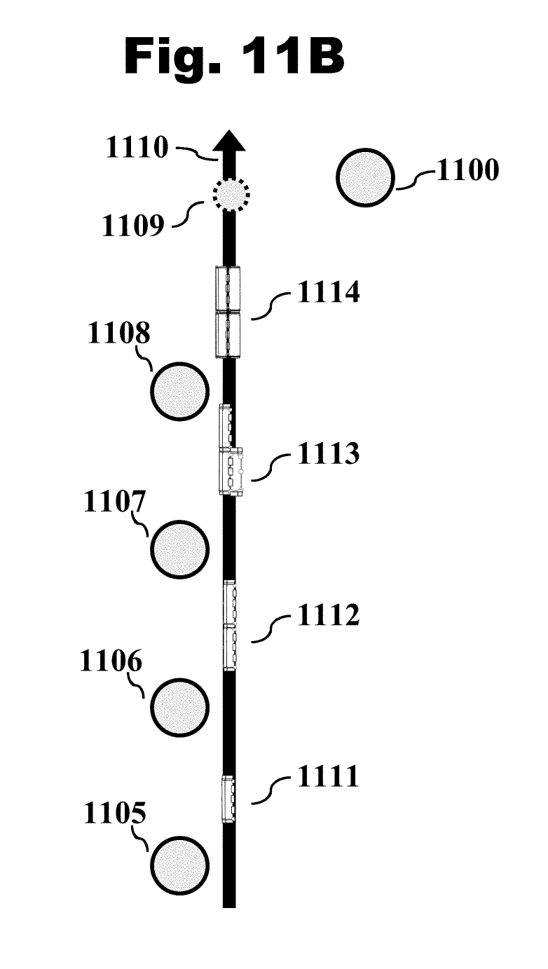

FIG. 11A shows a yacht assembled out of four privately-owned custom BBV units [1101]-[1104]. Two of the units [1101]-[1102] provide a public right-of-way [1115] through which pods can pass, and two of them [1103]-[1104] do not. The BBV units have numerous doors [1116]-[1119], which may be kept open or closed in the assembled yacht, providing exterior access for exterior facing doors, and interior configurability according to the owner's mood for doors which are interior-facing in the assembled yacht. The components of the yacht could be further customized as far as their fit and finish, furnishings, artwork, etc.

Whether or not a yacht or its components have a public right-of-way could be a function of tax incentives or other regulation. Like with the transportation of multi-modal shipping containers, discussed below, it is a public benefit to mitigate the impact on general traffic flow by the transport of large objects. That impact could also be reduced by keeping the yacht in its assembled state only while it needs to be in that state. Otherwise, the components travel separately. Imagine a yacht owner living high in the hills at [1100] overlooking a freeway [1110], as shown in FIG. 11B. Each of the components [1101]-[1104] of her yacht is stored in a lot along the highway, [1105]-[1108] respectively.

The snapshots [1111]-[1114] shown along the highway, are taken as each component leaves its lot and assembles into the growing yacht, so that by snapshot [1114] the yacht is complete. When the completed yacht reaches the boarding point [1109] the owner's feeder vehicle has also arrived, and will dock with the yacht allowing her to enter. To the extent permitted by curves, width restrictions, and other infrastructure limitations which might arise during the journey, the individual BBVs can remain docked together for the duration of the trip, creating a single large private interior space. Generally, the temporary and reversible joining of the enclosed interiors of container vehicles may be maintained for an arbitrarily long time, the time limited only by infrastructure constraints which arise during the joining.

In the event of a constraint, the space might have to partially or completely disassemble while en route to deal with a limitation (such as a narrowed road) only to reassemble in the desired configuration once the limitation is passed. Once the trip is completed, the components of the yacht could be directed to the same or other lots to prepare for a later trip, and private feeders can be similarly prepared.

This extreme example illustrates that many prized features of private transportation, the opportunities for luxury, customization, to display prestige or status, and so on need not disappear in the collective transportation regime. In fact, collective transportation provides luxury opportunities unimaginably greater than individual transportation does.

However, the simultaneous docking of vehicles both end to end and side to side, and the extension of docking time beyond the time needed for mere transfer of pods, features illustratively described here in relation to yachts, could have application in many other situations, far beyond the scope of creating private luxury. For example, a large performance space could be assembled from a number of BBVs docked together in various ways and remaining docked for the full time of the performance, as infrastructure permits. The performance might even incorporate rearrangement of the component BBVs en route, planned or unplanned, as part of its artistic structure.

Significant further applications arise from the technology for the temporary assembly of container automated vehicles to form larger mobile structures just described as it applies as well to containable vehicles, not just container vehicles. Pods could be assembled into larger units for transport, and keep together as well as it can be done given other constraints. In other words, containable automated vehicles may be temporarily and reversibly joined together so that they act as a single containable automated vehicle while they are joined.

For instance, pods dimensioned to transport a single person could be assembled together to transport a family. Where ever possible, the family unit would be kept together during all transfers between containers, so that the family members travel together and arrive at their destination together. Some circumstances might require the grouping and linking of pods to be temporarily undone, for instance, if transport is required in a container vehicle whose docking apparatus is dimensioned only for receiving pods dimensioned for a single person. The family would enter such a container one by one, and their group re-assembled once the units are inside the container. Pods might also be assembled in order to transport larger, indivisible, cargo. Such a grouping could not be undone during the entire journey of the cargo. The controller would have to arrange for there to be no obstacles to the passage of the pod assembly from container to container during a journey by choosing only appropriate containers for each segment of the journey. This is just another constraint among many that the controller would need to optimize against as it tries to manage pod flow in an efficient manner.

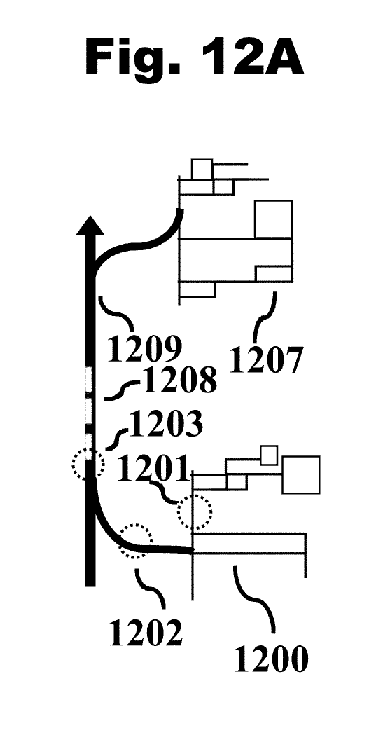

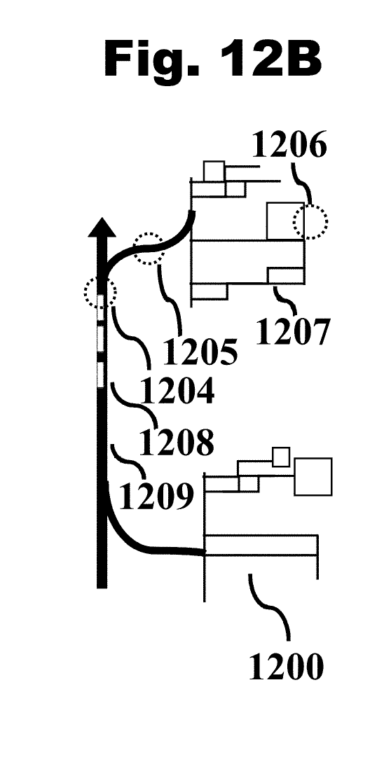

In FIGS. 12A-B, we provide an illustrative example of feeders doing the jobs of taking pods out to the highway, and then collecting pods from the highway to take them back to surface streets. FIGS. 12A-B both show a platoon of highway container automated vehicles [1208] traveling on a highway [1209] comprising exits to two neighborhoods of surface streets [1200] and [1207]. Feeders circulate in both neighborhoods [1200] and [1207]. They collect up pods in a neighborhood and feed them to the highway and they collect pods from the highway and distribute them in the neighborhood. Feeders are physically adapted to the roads in their local neighborhood. They need to be able to travel highways and match speeds with highway vehicles, but only for the time required to transfer their pods to or from a highway vehicle. Most of the time, they are roaming local streets, at slower than highway speeds.

We now follow the journey of a pod from neighborhood [1200] to neighborhood [1207]. At the position [1201], indicated by a dotted circle, a feeder picks up the pod. The feeder may continue to circulate in the neighborhood [1201] picking up more pods, it might exchange the pod it picked up with other feeders circulating in the neighborhood, or take the pod directly out to the highway [1209]. The feeder is in the process of doing that at position [1202]. When the pod is taken out to the highway by a feeder, the feeder docks with the passing platoon [1208] and transfers its pod to the platoon, this happens at position [1203]. The pod then travels the highway [1209] in the same platoon [1208] or possibly being passed among highway vehicles via dockings and transfers to other platoons. As the exit for the neighborhood [1207] approaches, at position [1204] (FIG. 12B), a feeder comes out to the highway to collect the pod from the platoon. At position [1205] the feeder is taking the highway exit towards neighborhood [1207], with its pod, perhaps along with other pods which it has picked up from highway vehicles, which pods also seek destinations in neighborhood [1207]. At position [1206], the feeder deposits the pod to the street at or near its destination, close enough that the pod can continue the rest of the way under its own power.

We have seen that pods can effectively move between container vehicles via docking of the container vehicles. But how do pods get into the first, and out of the last of a system of co-operating container vehicles? Mounting and dismounting is similar to docking, and is controller by a controller, which in addition to controlling all motion-relevant activities of all containable vehicles already contained, if any, within a given container automated vehicle may also control the motion-relevant activities of a non-contained containable vehicle which is not presently contained in any of said container automated vehicles and cause said non-contained containable automated vehicle to enter said given container automated vehicle, by co-ordinating all motion-relevant activities of said given container automated vehicle, said non-contained containable automated vehicle and said all motion-relevant activities of all said containable vehicles already contained within said given container automated vehicle so as to permit said non-contained containable automated vehicle to become contained in said given container automated vehicle, said controller may in addition and conversely cause any given containable automated vehicle contained within said given container automated vehicle to exit said given container automated vehicle without simultaneously entering another of said container automated vehicles whereupon said given containable automated vehicle is no longer contained.

In a typical scenario, the containable vehicle aka pod is moving along the street, and the feeder vehicle moves alongside it or in front of it. The feeder opens a door and the pod enters. This can be thought of as “bootstrap” docking in that the pod does not move between two docked container vehicles, but rather changes state from being uncontained to being contained in a single container vehicle. To bootstrap dock, the pod needs to match the speed of the feeder vehicle it will join, adjust its location to be in front of the door in the vehicle it will enter, and, typically, change the height of the surface from which it is getting traction. That is, from the street or platform on which it travels uncontained to the floor of the container vehicle in which it will be contained, which floor will typically be at different height than the street or platform. Adjusting speed and location for bootstrapping is something that both pod and container can work cooperatively together to achieve. The same is true of height adjustment, though one or the other of pod or container vehicle may have a primary role as far as each phase or aspect of the mechanics of docking. For instance, the container could have arms that reach out, grab a pod, and place the pod in its interior, or the pod could have arms to grab onto the container vehicle and pull itself up and into the container. Both pod and container vehicle might provide part of the lifting mechanism, which becomes operative when those parts work together.

As illustrated schematically in FIG. 13, to which we now turn, a ramp [1301] is a relatively simple means for a pod to mount or dismount a container vehicle [1300]. The ramp [1301] shown in FIG. 13 in an extended position. A pod [1302], in this case fitted for and containing a single person [1303], drives up to and then onto the ramp, entering the feeder vehicle [1300]. Preferably, this process may take place while both feeder [1300] and pod [1302] are in motion. Once the pod is inside, the feeder vehicle stows its ramp, closes its door, and continues on its way. The process reverses when it is time for the pod to dismount. Vehicles which use other technology to aid the pod in mounting and dismounting from a container will follow the same general pattern.

At present, cars mostly live outside buildings, and people mostly live inside buildings. Cars might have special indoor spaces built for them, such as garages or parking structures, but humans rarely live in those spaces. We can expect little change in this situation from the mere automation of road-worthy vehicles. They will not generally share indoor rooms with humans. But pods according to the present disclosure might be designed to be near the same dimension as humans, and might well occupy an indoor space along with humans. For instance, a pod could be designed to function as a living room chair, and yet also be mobile enough to take the occupant of that chair outside and onto the road, at least as far as is required to board a passing feeder vehicle. Preferably, such a pod would be equipped with shields which can be configured to protect its occupant from the elements outdoors, and be retracted indoors. It might have heating and cooling systems sufficient to comfort a passenger during the pod's brief excursions outdoors. Such a pod should be configurable to fit through de facto standard doors primary meant for humans. Building entrance standards might evolve to accommodate larger indoor/outdoor pods, just as they have according to the American Disabilities Act. For the purposes of the present embodiment, we can take pods as being configurable to pass through a doorway built in compliance with the American Disabilities Act.

Still, some residual indoor/outdoor transition might remain. To be readmitted inside, the pod may need to be dried, cleaned, sanitized, brought to room temperature, etc, any effects on the pod from having been outdoors reduced or eliminated. Homes may be equipped with dedicated cleaning stations which perform the required tasks on the pod near the threshold of the indoor space. In apartment buildings, these cleaning stations might be communal. Similarly, an establishment, commercial or otherwise, might wish to receive indoor-capable pods, and would therefore provide facilities to ensure that the received pods are indoor worthy according to the establishment's standards.

Given such indoor/outdoor pods, routing could be performed indoors, and across the indoor/outdoor threshold. Inside a building, the routing might be controlled by the general collective transportation system controller/router, or by a router which only controls movement of automated vehicles within the building. Within-building routing has application wherever one or more people may need or appreciate being directed in their motion inside the building. Examples include a hotel sending guests and their luggage to their room, a theatre directing people to their seats, a convention center directing conventioneers to their scheduled next meeting, and so on.

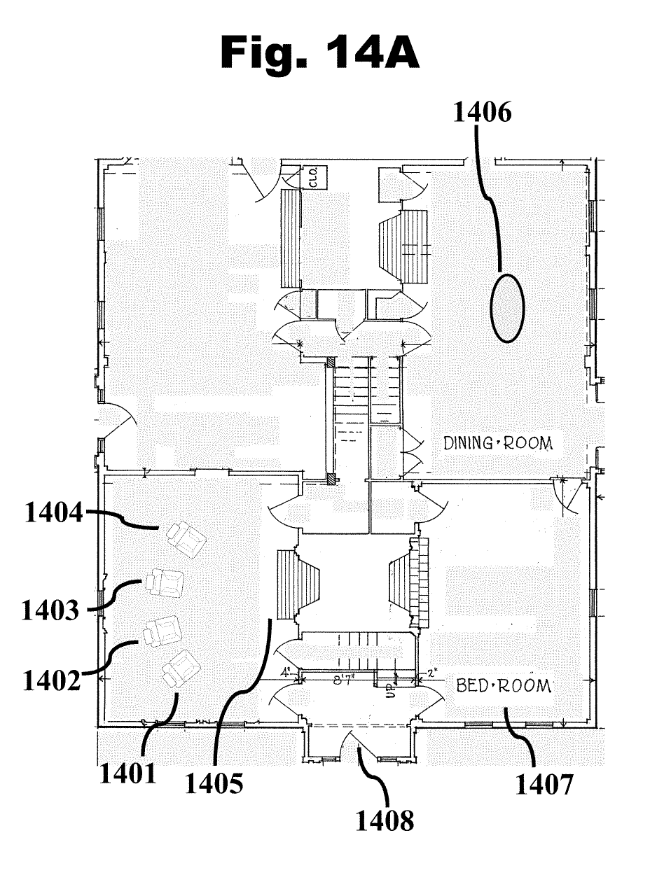

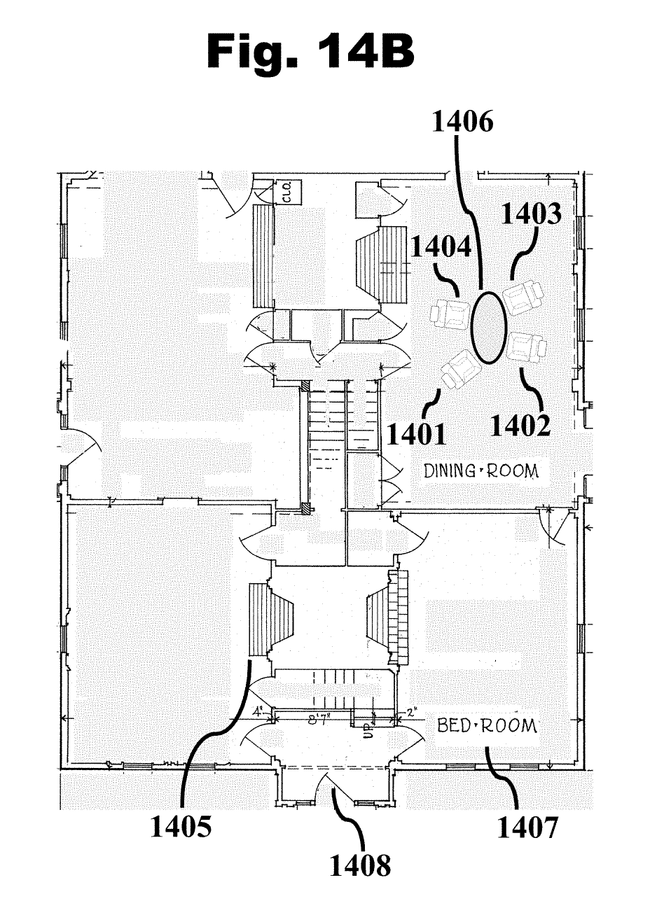

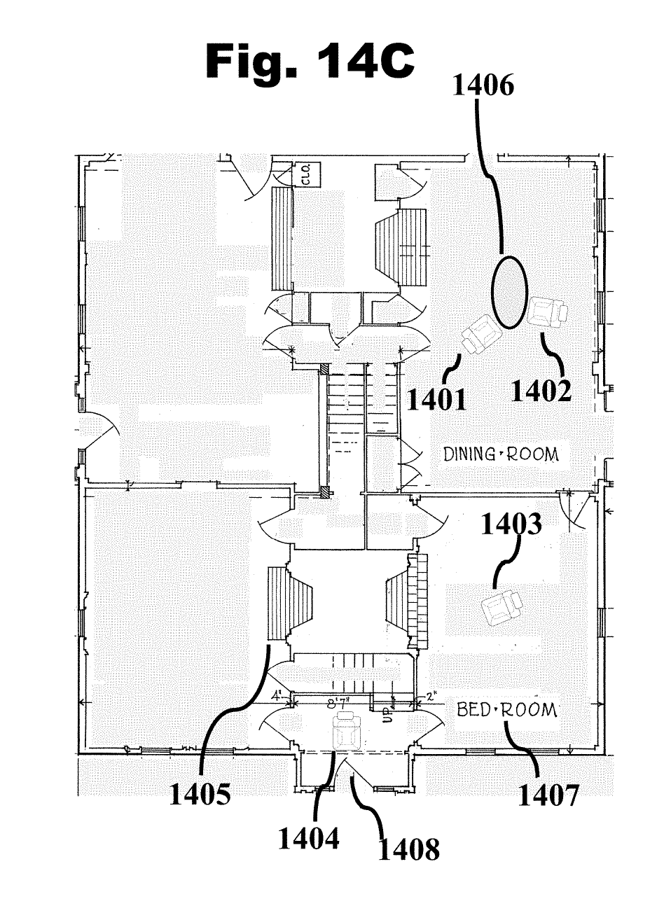

To further illustrate this concept, we turn now to FIGS. 14A-C, where we consider a household comprising two middle-aged parents, a 5-year old child, and a grandparent suffering from advanced dementia. Each of these is seated in an indoor/outdoor pod for illustration roughly similar to that shown in FIG. 1, but narrow enough to fit through the front door of the family house, equipped with a cover selectively positionally be protect the occupant from inclement weather, and configurable to comfortably support and transport the occupant sitting, reclining, or lying down, namely pods [1401]-[1404] respectively. The mother, seated in pod [1401], controls the movement of all of the pods as long as they are in her home, including that of the father [1402]. If the pods travel beyond the perimeter of the house, the general controller takes over control. In FIG. 14A, she has arranged the pods in a semi-circle in front of a TV [1405]. Later, as shown in FIG. 14B, she arranges the pods around a dinner table [1406]. Still later, as shown in FIG. 14C, mother and father remain at the dinner table in pods [1401]-[1402]. Pod [1403] containing the child is sent to the child's bedroom [1407], and instructed to flatten to a bed. The grandparent's pod [1404] is sent out of the house, its cover lowered and its heater turned on. The general controller is instructed to transport the grandparent's pod to a nearby assisted-living facility (not shown) through the front door [1408]. Crossing that threshold signals the general controller to take control of pod [1404] and will proceed to arrange its transport though a succession of container vehicles as we have described. Once pod [1404] crosses the threshold of the facility, the staff will take control of the pod from the general controller.

Just as the information internet become the substrate for many new online business, and is responsible for transforming many old ones, the transportation internet could be the catalyst for massive economic change and opportunity. One business which could completely merge with collective transportation is the business of refueling container vehicles themselves. Refueling is another example of the problem of members of one population, in this case, vehicles which need to be fueled, with members of another population which address that need, in this case, containable vehicles containing fuel. These problems are an extension of the basic function of collective action, which is to transport something from point A to point B. In this extension, the destination B is a moving target, as it itself is in the process of being collectively transported or is supplying transportation to other members of the collective. In the illustrative case of fueling, the vehicle to be fueled is on its own trajectory, fulfilling its own missions.

We have already seen that some vehicles are confined to travel on limited segments of roadway connected together to form a niche. The traditional model of having an individual vehicle travel to a service station to be fueled might be impractical to apply since it might entail at least one service station for every niche. Even if that could be done, it would be better for vehicles to keep moving as long as they've something useful to do, not stopping at service stations, and thus would be better to fuel them while they are in motion and providing transportation capacity.

For the purposes of this disclosure “fuel” is anything collective transportation vehicles run on, whether they are electric, fossil fueled, or other. If the fuel is such that it can be packaged in a cargo pod, then, if we can get the cargo pod to the vehicle to be fueled, all we need is a mechanism for the pod to transfer its fuel to the vehicle to-be-fueled. For illustrative purposes, in this embodiment we imagine fuel to be electrical charge contained in a battery, and that vehicles are refueled by being supplied with a fresh battery or having current run to them by a charged battery. The batteries could be charged at a stationary filling station, from which they mount container vehicles and travel to any vehicle needing a charge via the collective transportation mechanism. Once near enough the to-be-charged vehicle, they could communicate their fuel, and then return to the stationary filling station to begin the cycle anew In the case of container vehicles, being “near enough” could mean the pod delivering fuel is enclosed in the interior of the to-be-fueled vehicle. That is, we show here a collective transportation system of claim comprising fuel-transporting containable automated vehicles, said fuel being utilizable by said container automated vehicles, and further comprising a mechanism by which said fuel may be transferred from said fuel-transporting containable automated vehicle to container automated vehicles whereby said container automated vehicles are refueled.

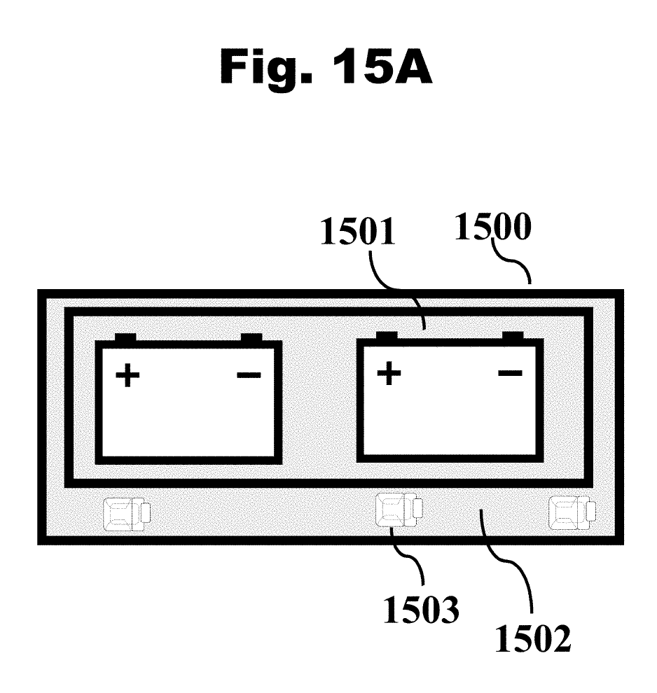

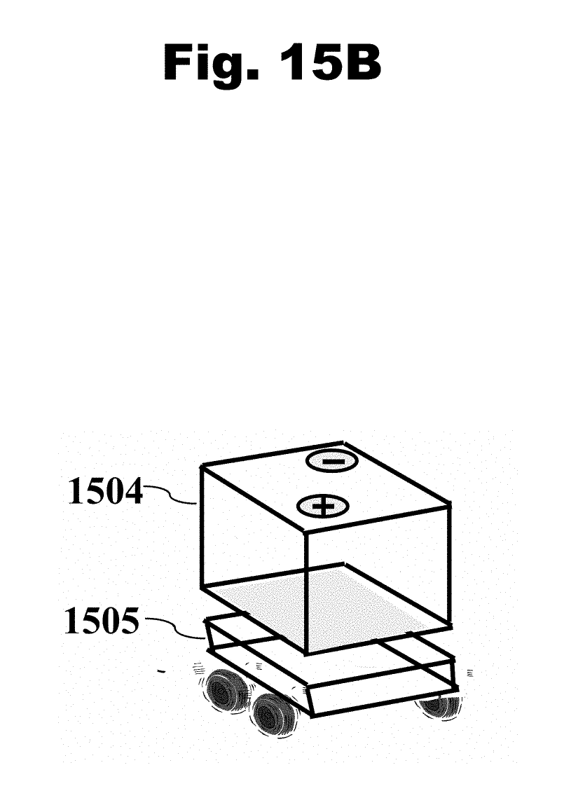

There would be advantages to having the fueling station which fuels the fuel-transporting pods to itself be mobile. A system with mobile fueling stations could deliver fuel in a more responsive and distributed manner. That is, we propose in this embodiment that batteries be charged from a “tanker” vehicle [1500] such as shown in FIG. 15A. The tanker contains a big battery [1501] which can charge smaller batteries and send them off in a pod such as [1503] to other vehicles which need them. The pods can circulate in the tanker [1500] via a passageway [1502]. The pod might be a special-purpose device which is effectively just a battery with automated vehicle capabilities. In FIG. 15B, we see an alternative, where the battery portion of a pod [1504] might be detachable from the mobility portion of the pod [1505] which supplies automated vehicle capacity. This would allow the battery to be deposited with any vehicle which needs refueling, and the mobility portion [1505] could return to a tanker or stationary fueling station to be loaded with another battery [1504]. In any case, the smaller batteries can circulate out of the tanker to find vehicles needing a freshly charged battery.

While the tanker itself might need to stop to have its large storage battery recharged, no other type of vehicle needs to stop for fuel in this embodiment, so the per-vehicle stopping time for refueling is negligible. Pods themselves would also need to be charged from time to time, but they would typically be kept at full charge by whatever container vehicle they are currently being transported in. When pods are stationary and un-contained, they might be charged from some stationary source. The pods could even feed that charge back into the transportation system when they are again on the move. The resulting energy distribution network could have far-reaching economic impact. Already home owners in some localities can generate electricity and get credit for feeding it into the electrical grid. The exchange of energy credit via the transportation network would be much more flexible and powerful, and thus have numerous presently unanticipated consequences.

In order to achieve maximum efficiency and minimize the likelihood of jams, all container vehicles which are presently circulating should be highly loaded with contained automated to the extent possible. On the other hand, more container vehicles in circulation tends to improve the options for the controller to find a container passing at the right time in the right direction to advance a given pod towards its destination. The system-wide optimization criterion is in conflict with the optimization criterion of a given vehicle, and these criteria must be balanced in one way or another.

In the following we will explore a number of illustrative solutions to simultaneous optimization against various constraints, either through the operation of the controller or by the deployment of specialized vehicles or some combination of both. Let's look again at FIG. 12, where a feeder vehicle enters the backbone, docks with a passing platoon and transfers one or more pods. In describing that process, we assumed that any needed vehicles would be available at the right time, place, and state to do what was needed. How can such events be reliably orchestrated? Say, for instance, that the window of opportunity to perform the feeder-to-highway vehicle docking of FIG. 12 is one minute long. That is, the feeder and the target highway vehicle can adjust their speeds such that they meet, dock, transfer all within that one-minute window. If platoons are passing frequently, say every 10 seconds, then finding a good target should be easy for the feeder regardless of when it enters the highway. But if traffic on the backbone is light, such that there a highway vehicle passes only every 5 minutes, then the feeder has to adjust more substantially. The feeder has spent time foraging for pods in the neighborhood before entering the highway to deposit them, that time might need to be adjusted. For instance, a feeder might break off foraging and head immediately to the highway if its controller knows that an appropriate platoon for the pods the feeder has already collected is soon to pass.

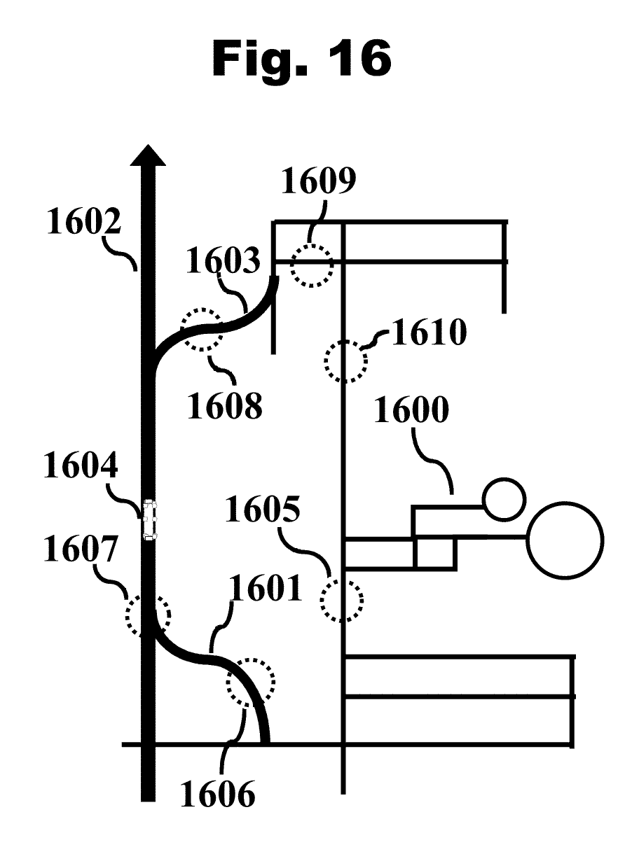

Alternatively, the feeder might delay its entry onto the highway until a docking opportunity arises. As shown in FIG. 16, the feeder could enter a holding pattern in the neighborhood, much as airplanes circle an airport waiting for an available runway on which to land. In the holding pattern, feeders enter and exit the highway, perhaps picking up still more pods from surface streets at each loop. As shown in FIG. 16, the feeder traverses the loop through the points [1605]-[1610] in sequence again and again, picking up pods as they become available on the network of surface streets [1600], entering the highway [1602] via entrance ramp [1601] and exiting via the exit ramp [1603] until it encounters a highway container vehicle [1604] to which it can dock within the time window, transferring all the pods it has collected. Alternatively, the feeder could just stay on the highway [1602] until it encounters a highway vehicle, adjusting its speed such that that time is minimized. That is, rather than waiting in a holding pattern, it could use up time by traveling relatively slowly on the highway, until a highway container vehicle behind it has time to catch up.

From a passenger's point of view, being in a holding pattern is sub-optimal. It would generally be better for them to wait at home until a good opportunity arises for transit to their destination, rather than experience delays en route. To the extent that the controller has control and knowledge over all docking/transfer events the passenger will experience over the course of a journey, it could offer the passenger a range of departure time/arrival time options from which to choose. This would allow the passenger to optimize the efficiency of transport for his or her point of view. The system may only offer times which are efficient from its point of view, e.g. Allow it to optimize loading of the container vehicles which will be used to transport the passenger during that intended journey. Thus, both passenger and system have the ability to affect the efficiency of transport for any given journey by timing the departure of that journey. More formally, we thus disclose a collective transportation system where the controller times the entry of any said containable automated vehicle into said collective transportation system so as to minimize the time said containable automated vehicle spends in transit or optimizes the efficiency of the collective transportation system. In FIG. 16, this would mean that pods do not leave their origin until the feeder is on the last turn of the neighborhood loop before it will enter the highway, and then just in time to board the feeder.

Beyond arranging good transport from a passenger's point of view, the controller should also control to optimize at the system level, making sure that capacity is distributed to optimally meet the current and anticipated distribution of transportation need. This might entail keeping vehicles of various kinds idled at various places, stockpiled and ready to be recruited into circulation, and withdrawing vehicles from circulation when they are temporarily not needed. Adjustments could be made short of adding or withdrawing container vehicles from circulation, such as when highway vehicles are nearing overload, temporarily passing some pods from a highway vehicle into a feeder vehicle traveling in the same direction, even though the highway vehicle generally provides the most efficient transport on a per pod basis.

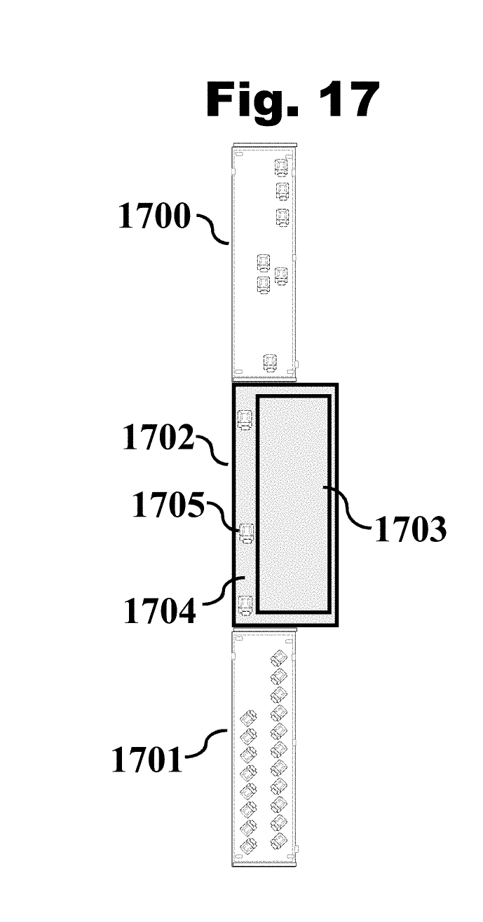

Current transportation systems are used to transport humans and other living beings, as well as inanimate cargo. Any extensive collective transportation system will have to do the same. We need to show that new system revealed here can embrace and extend the existing system. The challenge is exemplified by the need to simultaneously deal with passenger-sized pods and industrial transport of intermodal shipping containers, and even larger non-modular items transported by existing technology. Industrial transportation of large objects is based on a highly evolved and deeply engrained dimensional standards for intermodal shipping containers. Any new systems which requires these standards to be swept aside is not likely to be viable. Accommodating intermodal shipping containers and the like largely reduces to a technical problem requiring invention to solve: two container automated vehicles carrying standard passenger-sized pods need to dock to sort pods between them. However on the road (or other infrastructure) in between those two container vehicles there is another automated vehicle carrying a big intermodal shipping container or other cargo of similar bulk. That cargo vehicle cannot be passed, since the road is not wide enough for two wide vehicles to travel side by side, or if a rail system or similar, because the vehicles are traveling on a rail or similar. While the pods cannot go around the cargo vehicle, they can go through the cargo vehicle, if the cargo vehicle is equipped as in FIG. 17 to which we now turn.

FIG. 17 shows that vehicles carrying intermodal shipping containers can have passageways for pods, allowing pods to redistribute between pod-carrying vehicles which dock with the shipping vehicle to send pods along the passageway.

We have shown that container vehicles could be as wide as multiple standard lanes of traffic. A vehicle only as wide as a single standard lane for an interstate would be wide enough to carry a standard intermodal shipping container and provide a public passageway for single-passenger-sized pods of reasonable dimensions. Of course vehicles wider still could carry a shipping container and provide passage for bigger pods or assemblages of smaller pods, and/or be wide enough to allow simultaneous bi-directional traffic of pods. In FIG. 17 we see two container automated vehicles [1700]-[1701] containing pods. They are docked with another vehicle in the middle [1702] which is at least as wide as the width of a shipping container [1703] or similarly sized object plus the width of a pod, such as [1705] so that can contain a passageway [1704] running along the side of the shipping container through which pods can pass. Even with this single-width passageway, pod-carrying vehicles can readily exchange pods with each other, performing their function without interference from the cargo shipping going on simultaneously. While we have shown the public passageway as being placed next to the shipping container and running its length, other configurations are possible. If there is sufficient height clearance in a given infrastructure niche, passage for pods might be provided on a pod-carrying level above the shipping container, for instance.

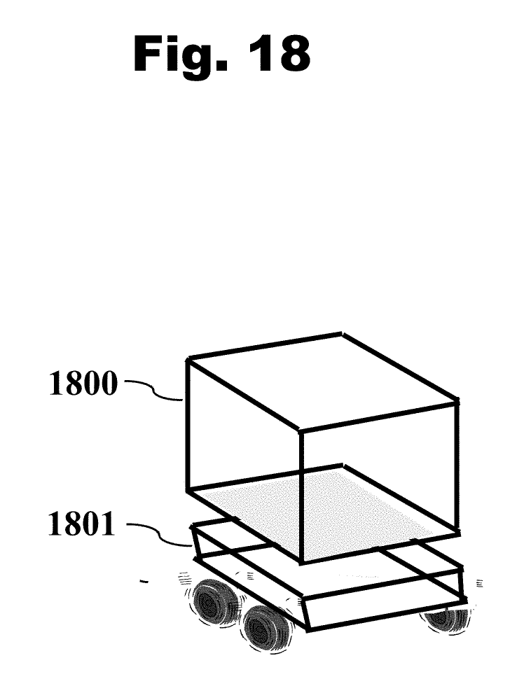

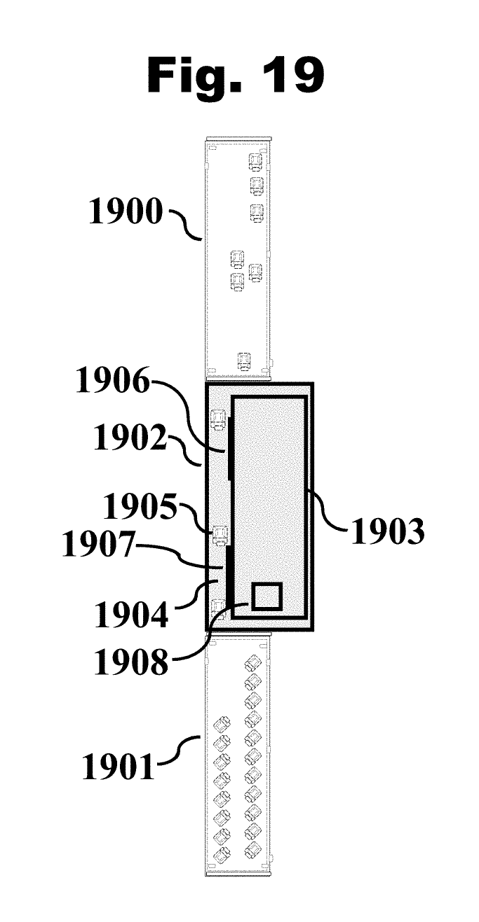

While a pod is in a sense a minimal participant in a collective transportation system since it carries things, moves under its own power, and is capable of being controlled by a controller which co-ordinates its movements with other members of the collective, it is worthwhile to consider the utility of dividing a pod into modules, at least one for object enclosure and the other for providing mobility to the object enclosure. As a major use of such modular pods is in conjunction with intermodal shipping containers, we will refer to such modular pods as mini-containers. FIG. 18 shows a modular pod (mini-container) with a mobility unit [1801] which detaches from the payload carrier [1800] which encloses the cargo as shown schematically. The mobility unit is a bare automated vehicle, able to participate in the collective transportation system, but not able to enclose meaningful cargo on its own, without the corresponding payload carrier [1801]. The mobility unit might be responsible for services needed by the cargo, such as refrigeration. When the payload carrier [1800] is removed the mobility unit those services might be supplied by machinery in the environment in which the payload is then placed. An illustrative example of the use of mini-container technology is discussed below in reference to FIG. 19.

It is commonplace in traditional transportation systems to load a shipping container at some location, ship it, and then unload it at some other location. Augmenting the traditional model using the novel technology just described, intermodal shipping containers could be loaded with the payload modules of mini-containers at some location, shipped, and unloaded at some other location. At the origin, the mobility units could be used to bring the payload modules to the container, and at the destination, the payload modules could be recombined with mobility units so that the mini-containers would be responsible for distributing the cargo at the destination. It would be more powerful, though, to load and unload intermodal shipping containers while they are being shipped. This is possible within the scope of the inventions of the present disclosure, as we will now describe.

Preferably, we dimension the payload containers of mini-containers such that they can compactly fill an intermodal shipping container. This could be the case if at least one dimension of a standard mini-container is a simple fraction of the corresponding dimension for standard full-size multi-modal shipping containers. Then we provide container automated vehicles which can contain standard multi-model shipping containers, such as were shown and described in connection to FIG. 17 with loading/unloading machinery for removing mini-container payload modules from the standard shipping container while it is in transit and attaching the payload modules to corresponding mobility units, or the reverse detaching payload modules from mobility units of mini-containers, and stowing the payload modules in an intermodal shipping container while in transit.

Referring then to FIG. 19, we see two container automated vehicles for containing and transporting pods [1900]-[1901] possibly including mini-container pods, another container automated vehicle [1902] for transporting pods, such as [1905] and intermodal shipping containers such as [1903]. The container automated vehicles [1900]-[1902] are shown at a moment when they are all docked together.

The container automated vehicle [1902] has a passageway [1904] allowing pods to flow into and out of [1902] for instance when it is docked with other container vehicles. That is, in a collective transportation system with a first, second, and third container automated vehicle, the third container automated vehicle may have an accessible part and a non-accessible part, such that when both the first and second automated container vehicles are temporarily and reversibly joined to the third container automated vehicles forming a joint enclosed interior space comprising the enclosed interior spaces of the first and second container automated vehicles and the accessible part of the third container automated vehicle, any of the containable vehicles contained in the first container automated vehicle may transfer to the second container automated vehicle via the accessible part of the third container automated vehicle, and the inaccessible part of said third container automated vehicle may to used to transport cargo, such as in an inter-modal shipping container. Further, the non-accessible part of the third container automated vehicle transports a standard multi-modal shipping container and the multi-modal shipping container can be loaded and unloaded while being transported by the third container automated vehicle.

The multi-modal shipping container [1903] is equipped with doors such as [1906] and [1907] which allow pods to enter the shipping container and interact with a coupler/decoupler [1908] which is responsible for coupling mini-container payload modules to corresponding mobility units, or uncoupling them. [1908] may also be responsible for storing the detached payload modules in the multi-modal shipping container [1903] or retrieving them from the container for separate onward shipment.

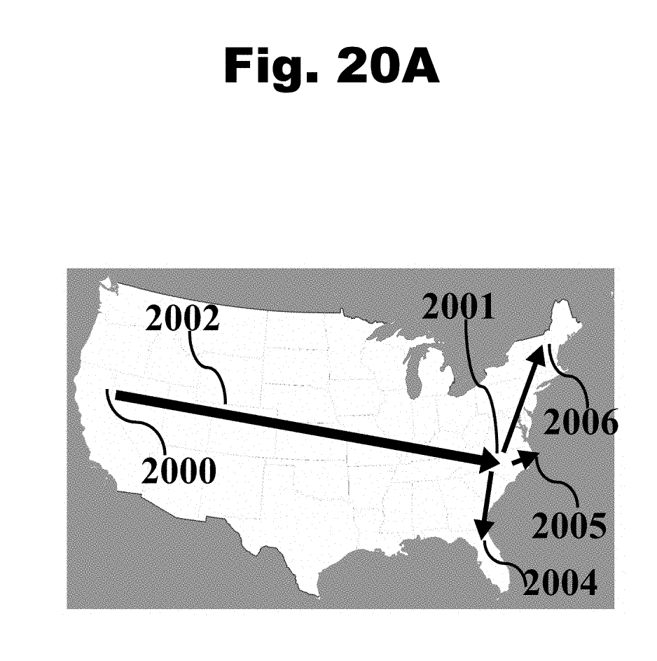

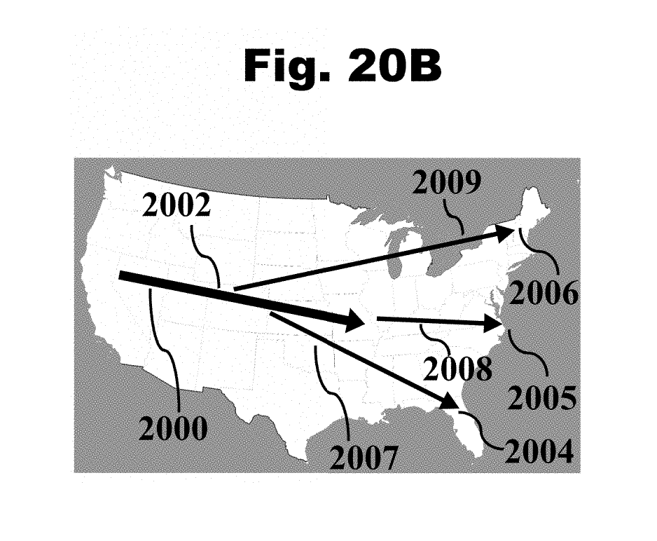

On one hand, this arrangement allows for a shipping container to be filled with cargo while it is in transit towards a final destination on the road network, such as a shipping port for further passage on a ship, or a train yard for further passage on a train. As it travels, the container can accumulate shipments, packed first into mini-containers, potentially from various suppliers. Each mini-container travels until it finds itself in a vehicle which docks with the vehicle containing its destination shipping container. Then the mini-container transfers to the shipping-container-containing vehicle and is packed into the shipping container. This is a vast increase in efficiency over loading a stationary shipping container, since the intermodal shipping container no longer has to stop at each supplier to receive a partial-container-sized shipment. It can accumulate cargo while it is en route. On the other hand, when the contents of a shipping container need to be distributed to end users, this distribution can also take place en route by the reverse of the process just described. We will describe this process in more detail in reference to FIG. 20.

The dynamics of shipping can be radically altered when mini-containers and full-sized containers work together. In effect shipping logistics and transportation are merged into a single entity as we shall now see. Say a container of apples and oranges the West Coast needs to be distributed to a chain of supermarkets on the East Coast. FIG. 20A shows how a collective transportation system built according to the present specification might be used according to a traditional shipping logistics method. A multi-modal shipping container is 1) filled on the West Coast, at [2000] 2) transported by a container vehicle via route [2002] to a distribution center on the East Coast at [2001] 3) there broken into smaller loads for other container vehicles which travel to each of the stores [2004]-[2006]. Though such a distribution topology could be implemented in a collective transportation system according to the present disclosure, in many circumstances, much more efficient shipping methods are available given this new technology.

FIG. 20B shows how a collective distribution system would preferably do this job. There is no distribution center, rather, the network itself does the distribution. A multi-modal shipping container is loaded into a container automated vehicle on the West Coast [2000], where it begins trading the route [2002] to the East Coast. Any time a store on the East Coast signals that it needs a re-supply, sub-shipments can leave the multi-modal shipping container in mini-containers as soon as they know where to go. e.g sub-shipments might leave for stores [2004]-[2006] via more direct routes [2007]-[2009] respectively. The reader understands by now that all of these routes would not be taken via a single vehicle, rather the mini-containers would be passed from container vehicle to container vehicle in a way determined by a controller which controls all relevant vehicles. The key lesson here is that distribution points are determined by information not geography, resulting in tremendous flexibility and efficiency. A sub-shipment is not broken out from the main shipment until the system knows that the sub-shipment is truly wanted at its destination. While the supermarket chain may accurately know the aggregate demand of all its East Coast stores at the time the load is assembled on the West Coast, it may not have a measure of the demand at each individual store. Whatever additional information the chain acquires while the shipment is in progress is immediately actionable by the collective transportation system. Each sub-shipment takes a direct-as-possible route to its destination, limited only by the timeliness of demand information. In a typical case the full container will be emptied well before it reaches the East Coast, at which point it can be released to other tasks, as indicated for the shortening of the route [2002] in FIG. 20B compared to FIG. 20A. Neither the full shipping container nor any of the mini-containers need to travel further than is necessary to deal with demand uncertainty, further increasing efficiency and reducing cost.

The reverse process, in which goods are aggregated to be shipped in a shipping container, benefits in the same way from just-in-time routing and mini-containerization combined with legacy multi-modal containerization.

The merger of distribution and transportation will have far-reaching effects on the shipping industry. It is to be noted any or all of a) the mini-containers, b) the shipping container containing vehicle, c) the shipping container itself, might be equipped to providing climate control (heating, cooling, ventilation) to the cargo, resulting in further speciation of vehicles. It should also be noted that this technology could have far-reaching impacts on the multi-modal container shipping industry itself, in many aspects of its operation. At present shipping containers are removed from container ships in a container port to be matched to trucks or rail cars as a function of the destination of the cargo. Containers containing mini-containers, by contrast, could be loaded onto effectively any truck or train leaving the port, since the routing of mini-containers to their final destination could take place later, while the container is already is en route. This in turn entails that container ports could have greater throughput and operate more efficiently in turning around container ships. While full-sized multi-modal shipping containers are not typically transported by air, mini-containers might readily be, leading to a major overhaul in the topology of many cargo-distribution networks, and reduced shipping time for at least some types of cargo, since they could easily have air links embedded in their path through the collective transportation network.

We saw in connection with FIG. 16, that when there are few vehicles in circulation, there may be delays for one container vehicle to find another container vehicle to dock with to facilitate the onward journey of its contained pods. This motivates a relatively even distribution of container vehicles over the infrastructure. There could be, however, countervailing motivations which leads to uneven distribution of container vehicles. One of these countervailing motivations is indeed preferable for efficient system-wide operation of a collective transportation system: container vehicles should be always loaded near their optimal capacity, which optimal capacity will generally be near full capacity. One mechanism for favoring optimal loading of container vehicles is a vehicle loading contrast-enhancement mechanism: the controller to acts to increase the contrast of container vehicle loading by transferring pods away from container vehicles of low loading and transferring containable vehicles to container vehicles which are more highly loaded, provided that the highly loaded vehicles are not already at or beyond their optimal loading. The contrast-enhancement mechanism creates a positive feedback loop whereby small differences in loading between two vehicles is enhanced. Consider two vehicles which are docked so that they can exchange pods between them. If there is any difference in loading between them, then, other things being equal, the mechanism will transfer a pod from the less loaded to the more loaded, unless the more-loaded vehicle is not already at its optimal capacity. This will tend to bring some container vehicles towards their optimal loading, and will drive other containers towards being empty. Empty vehicles can then be withdrawn from circulation, unless they are immediately needed for some other system operation, improving system-wide efficiency.

We thus present a collective transportation system where the controller optimizes against a plurality of system-wide optimization criteria, said plurality of optimization criteria comprising demand/capacity balance, throughput, tnet neutrality, and load contrast, where to enhance load contrast said controller acts to transfer said containable automated vehicles from lightly loaded said container automated vehicles and towards highly loaded said container automated vehicles, provided that said highly loaded container automated vehicles are not already at or beyond their optimal loading.

Contrast enhancement has the desirable feature of keeping the number of vehicles in circulation limited to the number needed to fulfill present demand. It also leads to platooning, and the creation of large platoons. The more vehicles in a platoon, the greater the opportunities for the contrast-enhancement mechanism to operate. Platoons are generally favored for facilitating pod exchange for other reasons, such as sorting pods according to destination, as we saw in reference to FIGS. 8A-D. Due to this and other factors, platooning tends to minimize the number of inter-vehicle transfers a pod needs to complete a trip. In high demand regimes, platooning allows the backbone to utilize more of its intrinsic capacity, since the platooning vehicles stay close together. The aerodynamics of close following may make platoons more fuel efficient. Platoons could also be safer, as we will discuss below The result of all these factors is a lumpy distribution of vehicles, with vehicles clumped together in platoons, interspersed with long empty regions of roadway (or other infrastructure).

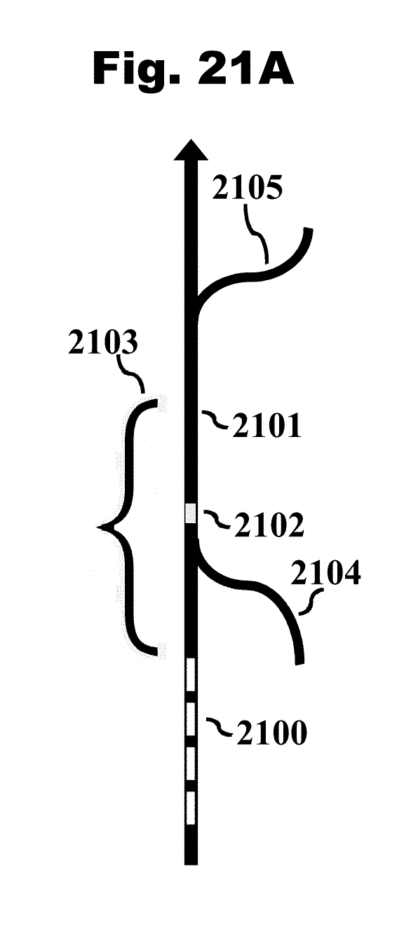

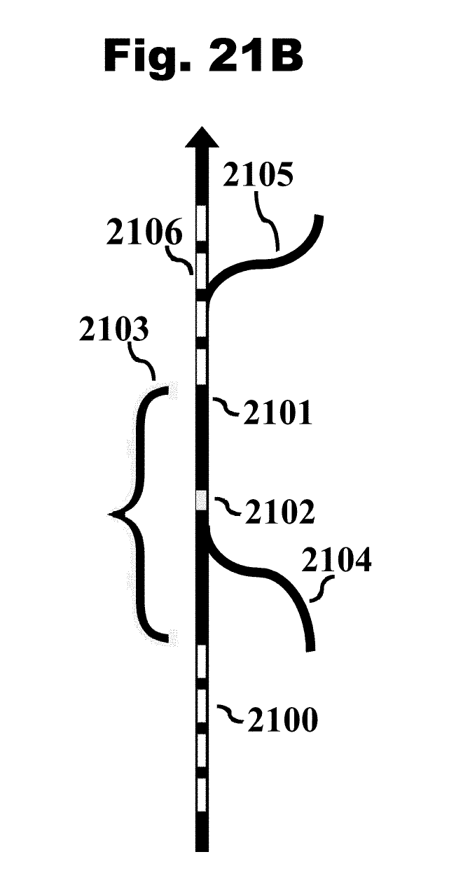

One approach to mitigating the deleterious effects of lumpy traffic is discussed in reference to FIGS. 21A-B, to which we now turn. Platoons are preferably equipped with companion vehicles with operate in conjunction with a platoon to enable it to better perform certain functions. One platoon function, as we saw in FIG. 16, is to collect pods from feeder vehicles. This function is aided by a scout vehicle, which scours the road ahead and/or behind a platoon seeking feeder vehicles to dock with. Thus, in FIG. 21A, we see a platoon [2100] and a scout vehicle [2102], traveling a highway [2101], with two accesses [2104] and [2105]. While the platoon vehicles typically travel at a constant speed, the scout vehicle can dart ahead or lag as required to search a wide range [2103] for feeder vehicles to dock with and collect pods from. Once the scout vehicle [2102] collects a pod, it can transfer it to the platoon [2100], and return to searching. The use of scout vehicles give feeders more flexibility in choosing the time to enter the highway from surface streets and generally gives the controller more options in planning the sequence of events which will take any given pod from its origin to its destination.

Referring to FIG. 21B, we discuss another function for platoon companion vehicles. Here the companion vehicle [2102] is used to effectively glue together two platoons [2100] and [2106]. In addition to providing scope to each of the platoons to collect pods, the companion vehicle can ferry pods between the platoons, in effect creating a super platoon. Pods might be transferred between platoons for any reason that leads to pods being routed between vehicles within a platoon, e.g. for the purpose of contrast enhancement. In this way, the companion vehicles allow the system to enjoy the benefits of platooning without unduly suffering the drawbacks. Any container vehicle capable of traveling on the highway could be deployed by the controller as a companion vehicle. However, the different functional demands on companion vehicles might be best met by vehicles purpose-built to serve those functions.

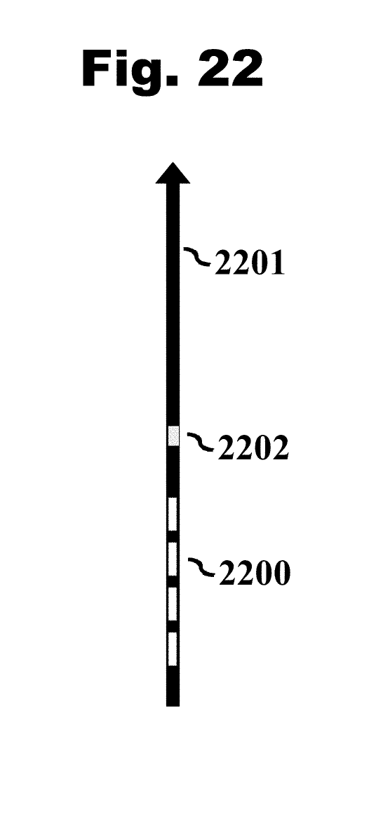

Yet another role to be filled by a platoon companion vehicle is that of providing safety for the platoon, in particular against unforeseeable sudden obstructions ahead of a platoon, such as a landslide onto a roadway or train track. Once one lead vehicle in the system has sensed the obstruction it can inform all the vehicles behind it so that they have time to avoid the obstruction even if the lead vehicle itself does not and is therefore sacrificed for the safety of others. Similarly, trailing vehicles might buffer the platoon against rear-end collisions, perhaps from a malware-infected automated vehicle. FIG. 22 shows an illustrative platoon leader [2202] traveling ahead of a platoon [2200] on a segment of infrastructure [2201] such as a road or a track.

While a platoon leading (or following) function could be performed by automated vehicles operating non-collectively, by simply reserving one platoon vehicle to be the leader, in collective transportation the leader can be created flexibly and on the fly. We have noted that pods might contain either passengers or inanimate cargo or both. Inanimate-cargo pods can and typically would flow with passenger pods. By a variant of the contrast-enhancement mechanism described above, the collective controller could favor the placement of cargo pods towards the front (and rear) vehicles in a platoon, and placement of passenger vehicles near the middle. The ready availability of cargo pods to be used for such purpose could be enhanced by offering shippers lower carriage rates for pods whose transportation path will be designed both to get the pod to its destination and to maximize transit of the pod in the lead vehicles of the platoons it will find itself in. It might be advantageous to build certain vehicles to be particularly well equipped to serve as leaders. They might have specialized crumple zones, for instance, or enhanced sensors for various kinds of hazards. It might be efficient to combine these safety-enhancement technologies with other technology adapted for other rare but important functions. For instance, the specialized lead vehicle might contain urgent-care or fire-fighting equipment, so that such equipment is well-distributed over the infrastructure and ready to be deployed anywhere at short notice. Similarly, a companion vehicle playing a dual role of police vehicle and scout might be fast and narrow, to be better able to navigate around and between platoons, even those composed of very wide vehicles. In general, a platoon might travel with an entourage of companion vehicles working with it in various capacities, leaders, scouts, glue vehicles, emergency vehicles and so on.

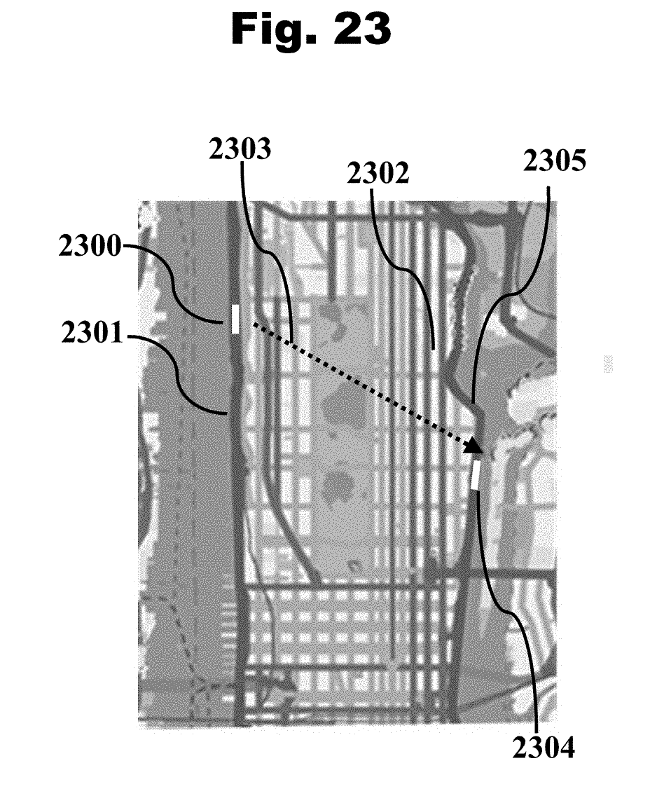

Automated aircraft known as drones are presently much discussed as potential parts of package-delivery systems. The problem with delivering packages directly to people by drones is that flying in airspace occupied by people is dangerous. Collective transportation offers a better and safer use of drones, which is to make ad hoc links between pairs of container vehicles traveling routes far from each other. FIG. 23 shows an example. Here we have a first container automated vehicle [2300] traveling down Manhattan's West Side Highway [2301] with a package for an address on the East Side of Manhattan [2302]. The first vehicle [2300] could transfer the package via drone along a direct path [2303] to a second container automated vehicle [2304] going up the FDR drive [2305]. This avoids terrestrially passing the package via a sequence of vehicles circulating in the interior of the city, and avoids the danger of flying drones near people. Ad hoc segments created by drones might be especially useful in maintenance activities in the collective transportation system itself, e.g. redistributing empty pods from where they are in excess to where they are needed, or ferrying supplies between segment of infrastructure which are not directly connected on the surface, such as vehicle batteries or spare parts.

An aspect of collective transportation systems as presented here which tends to raise alarm in the minds of persons of average skill in the art, is the aspect concerning docking of automated vehicles while moving, potentially at high speed. One thing such persons fail to appreciate is that docking can done in stages, where each stage creates the circumstances by which the next phase can be executed reliably and safely. These stages could involve increasingly strong mechanical connections as the vehicles approach each other. E.g at a long distance they could extend cables to each other which flexibly lash the vehicles together so that they could be drawn closer while mutually co-ordinating their motions via a physical link. Once they are close enough, stronger mechanical linkages could be extended to draw the vehicles still closer and make them still more rigidly connected, until still stronger linkages could be established, etc. An even less appreciated aspect of high-speed docking is the importance of informational, rather than mechanical linkages. The more and more precisely each vehicle knows the other vehicles three-dimensional motions, the safer docking can be.

This can be explained by adopting terminology around the docking of space vehicles. Space vehicle docking is conceived of having two main phases, a soft capture phase and a hard capture phase. During the soft capture phase, the vehicles collect information from each other as to their position, orientation, velocity and acceleration in order to perfect the alignment. Once the alignment is sufficient, the hard capture phase of docking begins, in which hardware fasteners needed to secure the vehicles together sufficiently well for transfer of contents between them can be fastened. We thus present a collective transportation system where the temporary and reversible joining of container automated vehicles occurs in successive phases, each of the successive phases involving increasingly rigid mechanical coupling of the container automated vehicles to be joined or increasingly accurate sensing of one of the container automated vehicles to be joined by the other.

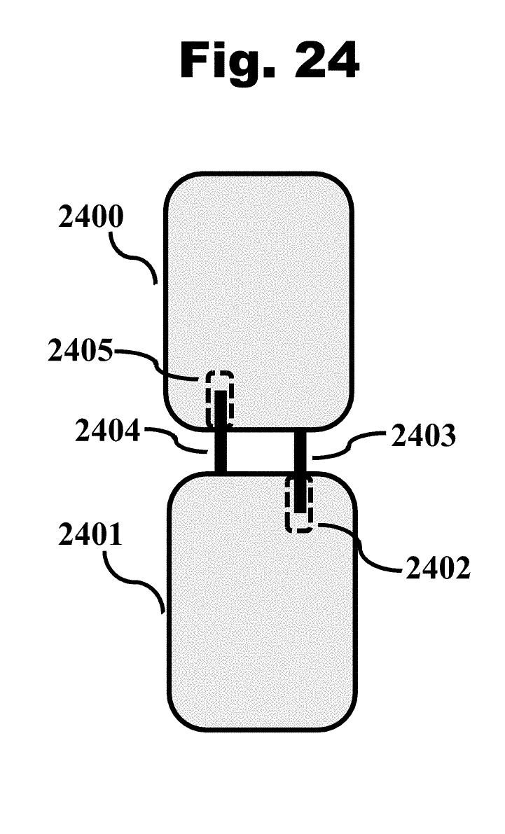

In FIG. 24 we consider a mechanism for the soft capture phase, the phase, above all, for the collection of information useful for docking. Here, each vehicle [2400]-[2401] is equipped with one or more probes such as [2403]-[2404] which can be inserted in a cavity such as [2402] and [2405] in the other vehicle. By being inserted in a space within the other vehicle, the vehicles are better able to judge each other motions and thus adapt their own motions accordingly. The motions of the probes in the cavities causes patterns of electromagnetic inductance in the cavity, or reflects laser light in the cavity, or some other electro-mechanical mechanism to translate the motion of each probe in its cavity to signals transmitted to both of the vehicles to allow them to gauge their relative motions and react to them. Precision and accuracy are high since each vehicle is performing measurements inside the other vehicle, even though the vehicles have not yet joined, perhaps not yet even touched. These signals can then be used to guide the two vehicles to draw still closer and to be in still more perfect alignment. It is possible that the sensors of the soft capture phase would be so accurate, and the control system of each vehicle so responsive to those sensors that the vehicles can effectively move as a single entity even while still in the soft capture phase. In that case, it is possible that no hardware fastening at all would be required for safe transfer of contained AVs to occur. If hardware fastening were needed or desired, the sensor system of FIG. 24 would allow the vehicles to align precisely enough that the fasteners could easily fasten. It is to be noted that the vehicles would need to respond to signals to align themselves not just in the direction of travel by controlling speed, but also in other dimensions and aspects by controlling pitch, roll and yaw. The sensor system of FIG. 24 would provide actionable feedback on all of these. The adjustments in response to the signals might be mediated, for instance, by the suspension systems of each vehicle so as to control pitch, roll and yaw as docking is consummated.

Up to now, we have generally assumed that a controller knows everything it needs to know about all the vehicles it controls. Such omniscience is not necessary, however, for effective control of a collective transportation system. Social insects, such as ants, are able to perform quite complicated tasks without any sort of global controller. They use only interactions with their neighbors, perhaps mediated by signals in the environment, such as pheromone trails. So it is with collective transportation systems, as we will show by exhibiting a collective transportation system controlled using only nearest-neighbor rules. That is, in this system a given vehicle decides what to do at any moment using only information about itself, its immediate environment, and information about the other vehicles closest to them at that moment. There is no global controller directing its behavior, or global information store it can search for clues on how to direct its own behavior.

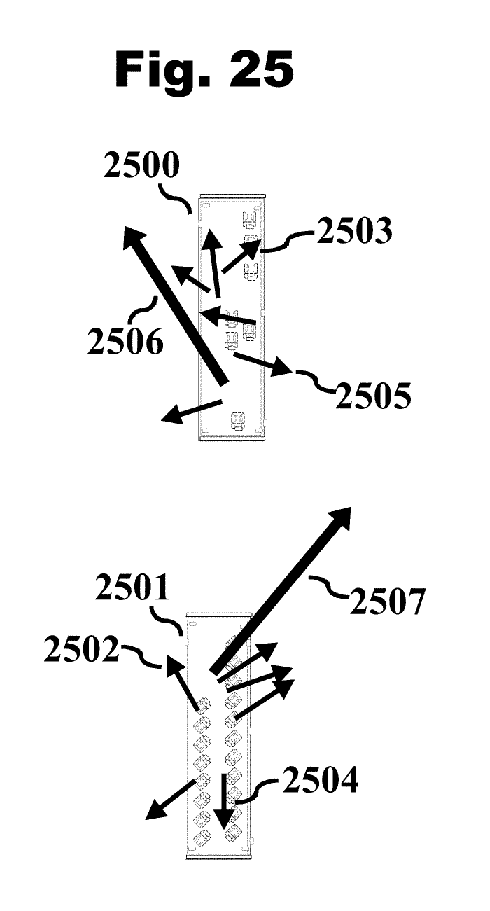

In FIG. 25 we see one container automated vehicle [2501] following another one [2500] down a road. Each carries pods, and each pods knows generally the direction to its destination as the crow flies. These directions are indicated by small arrows emanating from a pod, a representative sample of which is shown as [2502]-[2505]. Adding all those vectors together for pods in a given vehicle provides resultant vector for the whole vehicle. The resultant vectors are shown as [2506] and [2507] for container vehicles [2500] and [2501] respectively. Each container vehicle travels in the direction of its resultant vector, to extent it can given the roadway.

The container vehicles [2500]-[2501] obey the following rule: If a first and a second container vehicle are near each other on the same road, and either contains pod(s) whose vector is more aligned with the resultant vector of the other container vehicle, then first and second vehicles dock, and transfer the pod(s) whose vector is more aligned with the other vehicle's resultant vector. It thus does the best it can for the pods it contains as far as moving them towards their destinations, and it does this using only local information.

One can see that each of the container vehicles in FIG. 25 contains pods which would rather be in the other vehicle, since the pod vector is more closely aligned with the resultant vehicle of the other vehicle than the resultant vector of its own vehicle. For example the pod with vector [2502] would rather be in container vehicle [2500], and the pod with vector [2503] would rather be in vehicle [2501]. So following the above rule, the two containers dock, transfer all the pods which would rather be in the other vehicle and then undock. This process strengthens the resultant vehicles of each of the containers, which are recalculated after every docking event. On average, the more dockings the more each container contains pods all wanting to go more or less in the same direction, and that direction will be the resultant vector of the container vehicle.

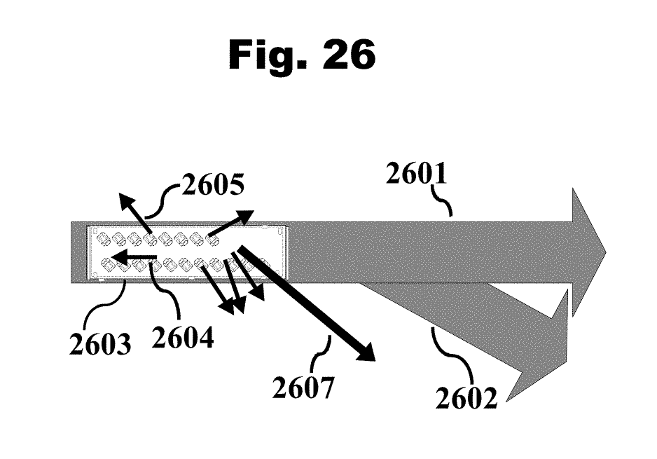

When faced with a fork in the road, the resultant vector can help a container decide which branch to take. In FIG. 26, a container vehicle [2303] is approaching a fork [2602] on its current road [2601]. Each branch of the road is also represented by a vector. This vector might be locally measured by the container vehicle, or locally broadcast to passing vehicles from the highway itself. Since branch [2602] has a vector closer in orientation that of the container vehicle [2607], the container vehicle takes that branch. No global controller is involved.

Note that some of the pods in the container vehicle of FIG. 26 point in a direction more or less opposite to the resultant vector of the container itself, for example [2604] and [2605]. By taking the branch [2602] the container [2603] is actually taking them away from their destination. Still, just applying the rules already given, the pods with vectors [2604]-[2605] would eventually get to their destination. Their speed to their final destination could be improved by layering on more rules on top of those already described. For instance, there could be other container vehicles traveling the same road in a circuit: entering the highway at one exit, traveling to the next, and then exiting to take the same highway in the opposite direction. The circuit-traveling containers broadcast a resultant vector pointing in the direction opposite the direction they are in fact traveling. Therefore, they pick up pods from other containers which would be better off going in the opposite direction they are currently traveling. Thus those picked-up pods soon find themselves traveling the highway in the right direction. The new rule speeds up the system as a whole, though it remains a nearest-neighbor rule. The new rule gives pods the ability to effectively make a U turn, though neither the pod itself or any of the container vehicles in the sequence which handle it “understand” the U-turn maneuver they are helping the pod execute. This kind of emergent behavior is familiar to those who study social insects.

Similarly simple rules could be exhibited which direct the motion of feeders, the mounting and dismounting of pods from container vehicles and the like. For instance, a pod may simply board any passing feeder it is able to catch up with, and to dismount whenever it finds itself close enough to its final destination that it could travel there under its own power.

A collective transportation system operating only with such myopic rules would probably not be very efficient, though it would work. Next-nearest neighbor rules could be more effective, next-next-neighbor rules still more effective, etc. A system in which each vehicle can benefit from knowledge about all the vehicles in a wide range in space and in time could operate with less waste, greater global throughput, and quicker individual trips. There is, however, a limit to the improvement available with increasing range of knowledge, as the actions of one part of the system becomes progressively decorrelated with the actions of other parts of the system as the distance in time and space to those other parts increases. This means that no controller will need to be omniscient and there will always be bound on the amount of computation needed to control collective transportation effectively. A controller for collective transportation could be implemented with computer technology already available, and can be expected to improve with improvements in computer technology.

Consider a case where a vehicle in a collective transportation is awash in global information. It has access to extreme detail concerning the movements, plans, travel conditions, contents, etc. of every other vehicle operating on the planet. Given that correlations between its own planning and motions and the planning and motions of other vehicles decays with distance, it would be useless and unwise to try to compute its plans based on all that information taken together. It would be better to operate in analogy to a mammalian retina, measuring with high acuity in the “foveal” region about its present position, and taking a more coarse-grained view of goings on farther away. The locality of information, and local relevance of actions in response to that information has numerous consequences as regards large-scale operations of the collective transportation system, and its relationship with public policy and regulation.

We will now present a framework for discussing locality which allows us to explore these issues. There are many other ways in which local and global can be technically bridged. This particular framework is sufficient to support the relevant discussion and to help us particularly point out specific features of note, though the technical means provided in a physical implementation of these embodiments may differ considerably from those we illustratively describe here.

More concretely, we consider a “cover” of a geographic area by control centers. We have already discussed controllers with dominion over a single building or a campus, but now extend that to controllers of arbitrarily limited domain. Each center, for didactic simplicity and without limiting intent, controlling activity in a circular control region around the center. Not every part of the geographic area needs to be included in a control region, and control regions may considerably overlap with each other. Also for simplicity without limiting intent, we assume that each control center controls all the vehicles in its control region, regardless of the transportation mode, ownership, or other factors concerning the vehicles.

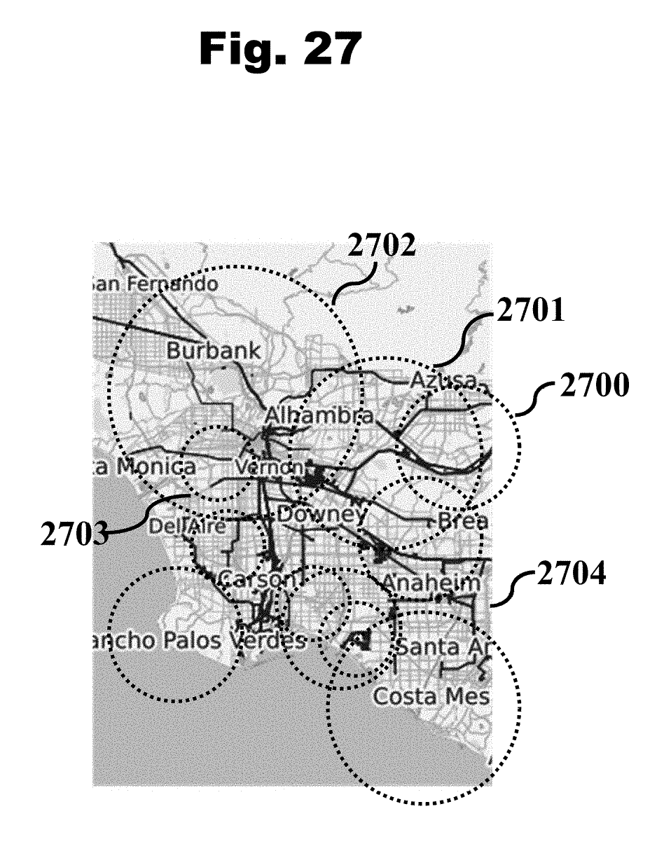

Turning now to FIG. 27 we see an illustrative cover of part of the Los Angeles metropolitan area by control regions. Each control region indicated by a circle with a dotted outline. We particularly point out that a) There can be multiple overlaps between control regions, e.g. [2700] and [2701] overlap, and [2701] in turn overlaps with [2702]. b) A control region can be entirely contained within another control region., e.g [2703] is entirely contained in [2702]. c) There may be geographic areas which are not in any control region, such as [2704]. In these regions vehicles might communicate with each other to set up peer-to-peer control to co-ordinate their activities.

Note that automated vehicles generally communicate with each other, even in a non-collective transportation system, and if only by mutual observation. At minimum, they need to adjust their movements in response to the information received by those observations to avoid collisions. Ideally these are not just nearest-neighbor communications, but communication with vehicles in some range. As is well known, collisions can cause chain reactions, pileups. This is one example of why knowledge of and adjustments to the motions of other vehicles should extend over some large range to enable safe and effective transport. Still, even the worse-ever pileup is small scale compared to the scale over which collective transportation system routing decisions may be productively made. The collective transportation system may work with information not just about the instantaneous motions of vehicles, but their travel and service goals and the travel and service goals of the vehicles they contain.

The concept of control region as elaborated here can be more generally thought of coordination of collective transportation system vehicles with each other not only via communication between the vehicles themselves, but also with infrastructure, governments, and inhabitants of the locality in which the vehicles travel.

We have already seen that a collective transportation system may need to balance many, possibly conflicting goals. For instance, an individual traveller might want there to be many container vehicles circulating nearby so that they can immediately find one to board, while the system as a whole might prefer to have as few vehicles circulating as possible, so as to minimize costs and/or decrease pollution. Different control regions could set the relative priorities of different optimization criteria differently. Some of the optimization criteria in a control region might have to do not so much with the operation of the collective transportation system as a means of transportation, but with the experience of people or things while being transported. For instance, some control regions might favor the ready availability of mobile food services and others might not. Food services could be provided, for instance, on a deck of a multi-deck highway vehicle. In one region the controller might work to keep such restaurant vehicles well-distributed throughout the region, while another might idle any such vehicle coming under its control, perhaps in favor of vehicles which use all their decks for pod carriage. When control regions overlap, some negotiation between the controllers would need to take place when optimization criteria and their weights are different between the regions.

We thus have a collective transportation system comprising control regions, each control region possibly covering a different geographic area and having different optimization criteria which guide decisions made by its controller concerning vehicle deployments, routes, loading, and other quantitatively measurable properties of the behavior of the collective transportation system.

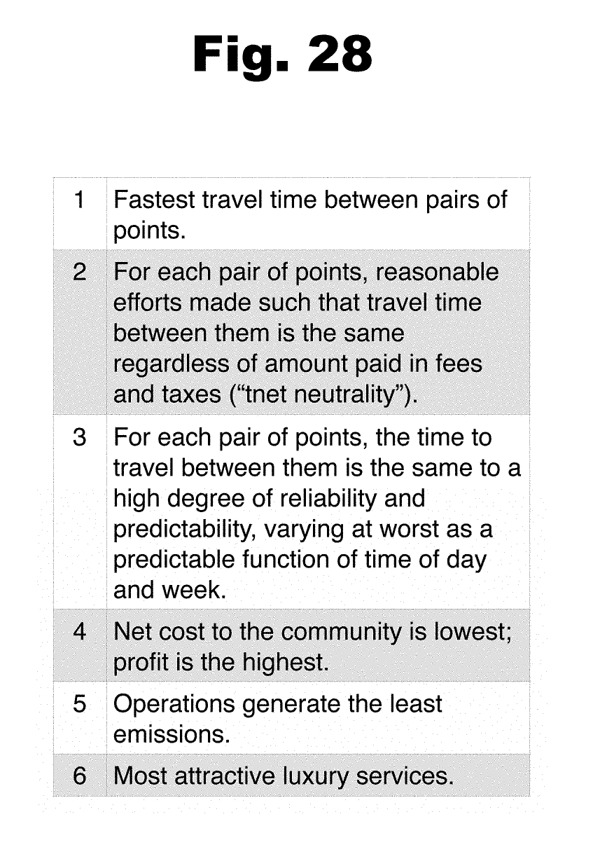

The types of criteria a controller might try to optimize against are essentially limitless, and each control region might optimize against several criteria simultaneously, in further unlimited combination. We provide a handful of illustrative examples in the table of FIG. 28. Here is a brief discussion of each of the criteria in the table.

Fastest time between pairs of points. For each point A and B in the control region, there is a time T_{AB} that it would take a single vehicle to travel from A to B, in the absence of obstacles. That is, T_{AB} is the travel time from A to B if there were no other traffic, no stop lights or signs, no accidents, no pedestrians to avoid, no bad weather etc, nothing that would prevent the vehicle from driving at the maximum legal speed at all times. A perfect control region would attain T_{AB} for all trips between all points A and B in the region at all times under all traffic and weather conditions.

Such perfection may not be possible in practice. Still, a control region would have numerous tactics available to it as it aims at perfection, on an average basis. For instance, to improve the average, it might help to increase speed between some pairs, while decreasing speed for other pairs. A control region competing on speed would be intolerant of traffic jams. It would do everything it can to keep traffic on all segments of its infrastructure below the critical density at which jams can occur. This might mean running higher capacity vehicles, which transport more pods per unit roadway, even if such vehicles are expensive to operate. It might also mean always providing an adequate supply of vehicles on the road such that no pod has to materially wait for any beneficial routing opportunity. It might mean sharp limits on the provision of value-added services if such would impact the average speed experienced by pods in the region.

Tnet neutrality By “transportation network (‘tnet’) neutrality” we mean that you can't pay for faster service between a pair of points A and B. This is a relative measure of speed, distinct from the absolute measure of speed discussed above. The net neutrality rule appeals to those who have a certain sense of fairness, and has analogy with the concept of “internet neutrality” applied to the information internet. In control regions which implement tnet neutrality, all routing decisions are made with reasonable efforts towards making travel between pairs of points the same for everybody; not the fastest possible speed, just the same speed regardless of what one has paid for the trip from A to B. Under tnet neutrality, people could pay more to have a better experience along other dimensions, such as paying for value-added services. Present commercial aircraft operate on this model, in that first, business and economy class passengers all take off and land at the same time, though other aspects of their flight experience may differ and cost differently

Neutrality may be evaluated as a function of time of day. For instance, during rush hour, the time to transit between a pair of points might be slower than it would be at other times. In this case, the neutrality commitment is only that anybody who leaves point A at about the same time will arrive at point B at about the same time later, regardless of what they pay for transport.

Reliability. One of the most annoying and wasteful aspects of traffic-limited transportation systems, such as that the present system implemented in Los Angeles, is the variability of travel times. It is well understood by any Los Angeles traveller that pessimistic guesses regarding travel time lead to useless waiting, while optimistic guesses lead to missed appointments. Optimizing for reliability means optimizing such that the travel time between a pair of points is always the same, to a close tolerance. Optimizing for reliability might result in slower times on average than could be achieved under other optimization regimes, but reliability might be more highly prized than raw speed.

To achieve reliability, the control region would certainly strive to avoid traffic jams at all cost. More generally, it would need to compensate forcefully for variations in demand on every segment of roadway. As we have already discussed, mechanisms such as scouts and glue vehicles can be deployed in low-demand situations to reduce or eliminate wait times, and more and larger vehicles can be deployed in high-demand situations to carry the extra load.

Demand in this sense would mean not just the number of pods and amount of cargo in transit, but also demand due to value-added services which use up space which could otherwise be used for pod or cargo transport. A simple example would be a service whereby a pod is transported with a zone of empty space created around it in any container vehicle the pod finds itself in, the controller routing other pods around that buffer zone traveling along with the pod with luxury service. Thus, such services might need to be curtailed when demand is so high as to challenge the intrinsic capacity of the network.

Profitability. The construction and operation of a collective transportation system might be paid for by fees and taxes collected from passengers and/or some mix of public and private funding. The fees, taxes, and funding might lead to a profit. Maximizing that profit, or at least minimizing the loss, might be the over-riding goal for some control area. This motivation might lead the control area to favor the provision of high-profit value-added services over basic commodity transportation. This might take the form of high-cost vehicles which have higher legal speed limits and take priority over lower-cost vehicles in any competition for infrastructure capacity utilization.

Operations generate the least emissions. Tactics to operate while generating the least pollutants might include routing pods to the most efficient container vehicles, which themselves are operated at their most efficient speeds. The control area might limit all transport, or just luxury transport which provides benefits other than mere transportation, etc.

Attractive luxury services. We discussed above the tactic to increase profitability by offering enhanced luxury, value-added services. Luxury services might be favored, however, regardless of their impact on profitability. Bringing people or corporations into the control area to use services might be beneficial to the control in ways other than profitability. The luxury services might even be a cost center for the control area. Residents of the community may simply demand them and/or providing such services could make the region a desirable destination for tourists.

We have shown that collective transportation systems are technologically feasible, and illustrated how they work. We will conclude this disclosure by showing that collective transportation systems are destined to displace prior-art individual transportation. Many scenarios can be presented for how exactly this will happen, but the most compelling arise from exploitation of network effects, where the value of a network grows more than linearly with the number of individuals participating in the network. A system subject to network effects grows via a positive feedback loop. Once a small number of individual nodes of the network are in existence, they recruit still other nodes increasingly readily, since the benefit to each new node is greater than the benefit experienced by the existing nodes when they joined the network, which was already greater than the benefits they had before they joined the network. A familiar recent example is Facebook, which new members join because many of their friends are on Facebook, the friends already in the network benefit from the new friend joining, and new members recursively provide the bait for their friends to join and so on until everybody in the world who has any friend at all is on Facebook. To show that collective transportation systems within the scope of the appended claims will take over from prior-art transportation systems, we need only to show that these new systems are subject to strong network effects.

Consider a transportation system so small that it consists only of a single pod and a single container vehicle, both owned by a single individual living out in countryside far from a shopping mall. Store the container away from the house, use pod to move in the house and to join the container for trips to the shopping mall. The single individual has a positive benefit as compared to just having a container vehicle which it uses for all transportation like a person would use a traditional car, human driven or driverless.

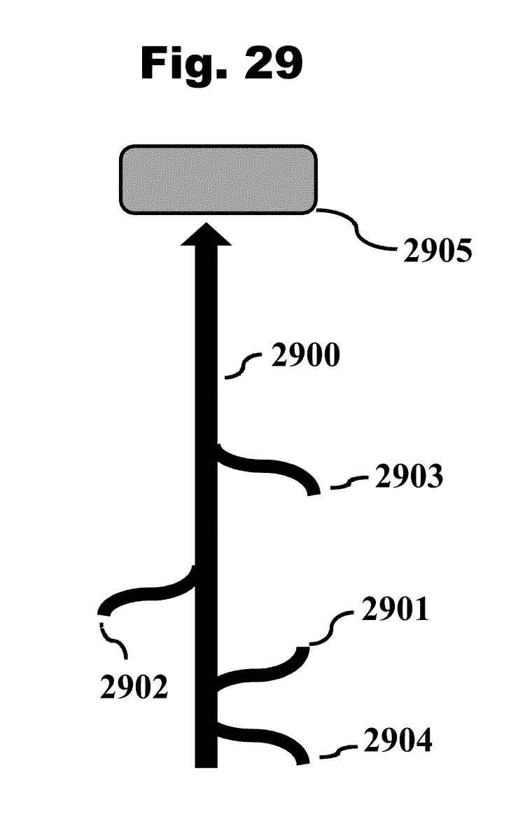

To make this more concrete, we turn to FIG. 29 for an example road topology on which this individual could operate their container/containable vehicle combination. In this figure, the individual lives at [2901], a five-minute drive from a road [2900] leading to a shopping center [2905]. The road [2900] is within the range the pod can drive on its own from [2901], but getting to the shopping center [2905] requires use of the container vehicle to transport the pod, say thirty minutes away. Container vehicles in this example hold up to four pods.

Now a neighbor living at [2902] acquires the same system, and the first and second individuals decide to co-operate when it is possible and saves time and/or money This could happen in several ways. When the individual at [2901] leaves for the shopping center first, he could signal the individual at [2902] to leave the house in her pod at the right time so that her pod arrives at the road [2900] as the container vehicle from [2901] is passing so that they can share the container vehicle for the rest of the trip. The individual at [2901] benefits since he can share the cost of operating the container vehicle for part of the trip, and the individual at [2902] does not have to use her container vehicle at all. Both, however, must pay the cost of timing their trips so that synergies occur. Since the waits, if any, take place while the individuals are at home rather than en route, the inconvenience should be small. If the individual at [2002] leaves first, then their vehicle would have to backtrack to pickup the individual at [2001], which would be an additional cost, making this pattern less favored.

Now a third individual living at [2003] joins the collective, and the opportunities for cooperation grow Each individual runs their own container vehicle less frequently and over shorter distances, saving money. The cost in waiting time decreases since there are more trips to the mall being made by neighbors and thus a greater likelihood that a shared trip could happen without undue waiting. Different potential patterns of co-operation emerge at this point. All three individuals might use a single container vehicle to transport them. But it might be better, depending on each individual's preferred departure and/or arrival times, to use two container vehicles for the three individuals on any given trip. The default is always available of using three container vehicles, reverting to essentially individual transportation. The possible patterns expand still further when a fourth individual, at [2004], joins the collective. Now there can be anywhere between one and four inclusive container vehicles in circulation at any one time, the number and their pattern of circulation being determined by a controller which computes the pattern which is best at simultaneously reducing costs and waiting times. When a fifth individual joins the collective, it will always take more than one container to circulate in order to transport all individual pods at the same time, since each container can only hold four pods. This would tend to increase costs, but is compensated by increased opportunities for the controller to find a pattern which reduces waiting times, and loads circulating vehicles optimally to decrease costs, benefiting both the newly joining individual and those already in the network.

As the number of participating individuals increases, the waiting time for a sharing opportunity approaches zero. The distributions of waiting times, container vehicle loading and other system measurements approach continuous distributions. When the waiting time is small enough, the time it takes for a pod to mount and dismount a container vehicle, and the time it takes for two container vehicles to exchange pods become relevant. It is at that point that technologies we have described for mounting, dismounting, and docking become relevant as well, since they operate to reduce the transaction costs for these pod-exchange activities. The more the activities can be done while the relevant vehicles are moving, the less they have to slow down to engage in these activities, the smaller the dwell times.

Individuals may join together to purchase larger vehicles, more efficient vehicles to travel the part of the route nearest the shopping mall. That way they can reduce the use of their individual container vehicles still further. Eventually the shared containers mutually purchased become as large as they can be given the physical constraints of the road leading to the shopping center.

As the sharing communities grow, sharing can beneficially happen not just between individual neighbors, but between nearby communities. By merging their local sharing systems, the nearby communities have more purchasing power to obtain vehicles better adopted to the various infrastructure niches over which they typically travel, not just the road leading directly to the shopping center, but roads feeding into that. Eventually, any person holding out from using the collective system, insisting on using their own individual transportation, will find that the cost to do so becomes prohibitive when compared to the costs experienced by their neighbors already using the collective system.

While we have just described network effects in reference to the adoption of collective transportation systems for human passengers, the same remarks apply, even more forcefully, to transportation systems for inanimate goods. Any shipper implementing a collective transportation network for distribution of goods will have a competitive advantage over shippers depending on prior-art individual transport. Since the shipper already controls many vehicles, they do not need to depend on network effects to grow a collective transportation system but can impose collective behavior by fiat. The competitive advantage of collective transportation will be emulated by other shippers, so that they all eventually adopt the technology disclosed herein. They might then merge their systems to gain still greater network effects, though doing so would force them to seek other kinds of competitive advantage. We have already seen through several embodiments how shipping and personal transportation can merge into a single collective flow. Thus there is no fundamental barrier for growing personal-collective transportation systems to merge with goods transportation systems operating in the same area, and they would be motived to merge in order to mutually enjoy still greater network benefits.

What is claimed is

1. A collective transportation system comprising a plurality of container automated vehicles, a plurality of containable automated vehicles each of which may be contained in members of said plurality of container automated vehicles, and when a given said containable automated vehicle is contained within the enclosed interior of a given said container automated vehicle, said given containable automated vehicle may move about within said enclosed interior of said given container automated vehicle.

2. The collective transportation system of claim 1 where said container automated vehicles can contain more than one said containable vehicle, and further comprising a controller which controls motion-relevant activities of said containable vehicles contained within a containing said container automated vehicle, said controller able to cause said contained containable automated vehicles to move about within said enclosed interior of said container container automated vehicle, whereby said controller can rearrange relative to each other each said contained containable automated vehicle within said enclosed interior of said containing container automated vehicle.

3. the collective transportation system of claim 2, such that when a first member of said plurality of container automated vehicles contains a to-be-transferred member of said plurality of containable automated vehicles and a second member of said plurality of container automated vehicles has room to receive and contain yet another member of said plurality of containable vehicles in addition to any of said containable vehicles already contained in said second container automated vehicle, then said controller may coordinate the motion and other transfer-relevant actions of said first and second container automated vehicles as well as actions of said to-be-transferred containable automated vehicle so as to effect the transfer of said to-be-transferred containable automated vehicle from within said enclosed interior of said first container automated vehicle to said enclosed interior of said second container automated vehicle whereupon said to-be-transferred containable automated vehicle is contained in said second container automated vehicle and is thereby deemed to be transferred.

4. The collective transportation system of claim 3 where said transfer-relevant actions of said first and second container automated vehicles includes temporary and reversible joining of said enclosed interiors of said first and second container automated vehicles forming a joint enclosed interior space such that said to-be-transferred containable vehicle may transfer from said first container automated vehicle to said second container automated vehicle while wholly within said joint enclosed interior space.

5. The collective transportation system of claim 4 where said temporary and reversible joining of said enclosed interiors of said first and second container automated vehicles may occur while both said first and second container vehicles are in substantial motion with respect the infrastructure on which they travel.

6. The collective transportation system of claim 1 where the plurality of container automated vehicles includes a sub-plurality of road vehicles designed for travel on roadways, said sub-plurality comprising optimized sub-pluralities of container automated vehicles optimized relative to one or more infrastructure standards created by a well-established standards-setting body, including standards for road width, clearance height, or design speed, where members of each said optimized sub-plurality are optimized with respect their utilization of the intrinsic capacity of said roads built to said infrastructure standard which defines said optimized sub-plurality of container automated vehicles.

7. The collective transportation system of claim 6 where one of said optimized sub-pluralities of container automated vehicles is a clearance-height optimized sub-plurality such that a container automated vehicle in said height-optimized sub-plurality has a height such that it can contain more than one level for transport and rearrangement of said containable automated vehicles, said levels connected via an elevator capable of transporting said containable automated vehicles between said levels.

8. The collective transportation system of claim 4 where said temporary and reversible joining of said enclosed interiors is such that said joining may be maintained for an arbitrarily long time, said time limited only by infrastructure constraints which arise during said joining.

9. The collective transportation system of claim 1 where said containable automated vehicles may be temporarily and reversibly joined together so that they act as a single containable automated vehicle while they are joined.

10. The collective transportation system of claim 4 further comprising a third said container automated vehicle, said third container automated vehicle having an accessible part and a non-accessible part, such that when both said first and second automated container vehicles are temporarily and reversibly joined to said third container automated vehicles forming a joint enclosed interior space comprising said enclosed interior spaces of said first and second container automated vehicles and said accessible part of said third container automated vehicle, any of said containable vehicles contained in said first container automated vehicle may transfer to said second container automated vehicle via said accessible part of said third container automated vehicle, and said inaccessible part of said third container automated vehicle may to used to transport cargo.

11. The collective transportation system of claim 2 where said controller, in addition to controlling motion-relevant activities of said containable vehicles already contained, if any, within a given said container automated vehicle may also control the motion-relevant activities of a non-contained containable vehicle which is not presently contained in any of said container automated vehicles and cause said non-contained containable automated vehicle to enter said given container automated vehicle, by co-ordinating motion-relevant activities of said given container automated vehicle, said non-contained containable automated vehicle and said motion-relevant activities of said containable vehicles already contained within said given container automated vehicle so as to permit said non-contained containable automated vehicle to become contained in said given container automated vehicle, said controller may in addition and conversely cause any given containable automated vehicle contained within said given container automated vehicle to exit said given container automated vehicle without simultaneously entering another of said container automated vehicles whereupon said given containable automated vehicle is no longer contained.

12. The collective transportation system of claim 1 where said containable automated vehicles are configurable to pass through a doorway built in compliance with the American Disabilities Act.

13. The collective transportation system of claim 1 where said plurality of containable automated vehicles contains a sub-plurality of fuel-transporting containable automated vehicles, said fuel being utilizable by said container automated vehicles, and further comprising a mechanism by which said fuel may be transferred from said fuel-transporting containable automated vehicle to said container automated vehicles whereby said container automated vehicles are refueled.

14. The collective transportation system of claim 2 where said controller optimizes against a plurality of system-wide optimization criteria, said plurality of optimization criteria comprising demand/capacity balance, throughput, tnet neutrality, and load contrast, where to enhance load contrast said controller acts to transfer said containable automated vehicles from lightly loaded said container automated vehicles and towards highly loaded said container automated vehicles, provided that said highly loaded container automated vehicles are not already at or beyond their optimal loading.

15. The collective transportation system of claim 2 where said controller times the entry of any said containable automated vehicle into said collective transportation system so as to minimize the time said containable automated vehicle spends in transit or optimizes the efficiency of said collective transportation system.

16. The collective transportation system of claim 1 where said containable automated vehicles comprise a mobility unit reversibly detachable from and reattachable to a cargo-carrying unit.

17. The collective transportation system of claim 10 where said non-accessible part of said third container automated vehicle transports a standard multi-modal shipping container and said multi-modal shipping container can be loaded and unloaded while being transported by said third container automated vehicle.

18. The collective transportation system of claim 1 where said said container automated vehicles can travel in platoons, said platoons comprising said container automated vehicles specialized to act as scout, glue, or platoon leader vehicles.

19. The collective transportation system of claim 1 where said plurality of containable automated vehicles includes drones.

20. The collective transportation system of claim 4 where said temporary and reversible joining occurs in successive phases, each of said successive phases involving increasingly rigid mechanical coupling of said container automated vehicles to be joined or increasingly accurate sensing of one of said container automated vehicles to be joined by the other.
